(19) United States
(12) Patent Application Publication
(10) Pub. No.: US 2021/0407020 A1
(43) Pub. Date: Dec. 30, 2021

(54) SYSTEM AND METHOD FOR THE SYSTEMATIC ANALYSIS OF ENERGY AND WATER BILLING DATA AND THE AUTOMATED FILTERING, DIAGNOSIS, AND VALUATION OF ANOMALIES IN THE DATA

(71) Applicant: Joseph Anthony Zaloom, Falls Church, VA (US)

(72) Inventor: Joseph Anthony Zaloom, Falls Church, VA (US)

(73) Assignee: E3 Analytics Corp., Falls Church, VA (US)

(21) Appl. No.: 17/364,184

(22) Filed: Jun. 30, 2021

Related U.S. Application Data
(60) Provisional application No. 63/046,373, filed on Jun. 30, 2020.

(51) Int. Cl. G06Q 50/06; G06Q 30/04

(52) U.S. Cl. CPC G06Q 50/06; G06Q 30/04

(57) ABSTRACT

A computer implemented system and method for eliminating hidden operating and financial waste in energy and water consumption and costs with maximum efficiency and economy by systematically analyzing energy and water billing data from almost any source and automatically filtering, diagnosing, and valuating the anomalies in the data.

### CROSS-REFERENCE TO RELATED APPLICATIONS

This application claims priority to U.S. Provisional Application No. 63/046,373, filed on Jun. 30, 2020, the entire contents of which is hereby incorporated by reference.

### FIELD

This technology relates to the field of smart energy solutions for the elimination of hidden operating and financial waste in energy and water consumption and costs.

### BACKGROUND OF THE INVENTION

Utility bill management companies, energy dashboard companies, and submetering companies are providing building owners and operators with an ever-expanding amount of energy and water data—without being able to filter and diagnose the anomalies in the data. It is akin to a doctor who can deliver detailed blood tests and MRI scans but cannot filter and diagnose the anomalies in the data.

Building owners and operators do not have the knowledge, time, and resources to filter and diagnose the anomalies in their energy and water data—overlooking massive amounts of ongoing hidden operating and financial waste. Waste, such as inefficient operations, demand spikes, water leaks, steam leaks, equipment problems, malfunctioning meters, erroneous charges, erroneous pricing, erroneous taxes, uncredited discounts and allowances, unclaimed discounts and allowances, unhedged commodity prices, uncredited payments, hidden charges within past due amounts, and unnecessary utility accounts, among other things.

The purpose of the above-referenced technology is to empower organizations to systematically analyze their energy and water consumption and costs and eliminate hidden waste in their use, prices, and related costs—as it occurs—by systematically filtering, diagnosing, and valuating the anomalies in the data. Diagnoses which would normally take days and weeks to perform are performed instantly.

This matters because eliminating hidden energy and water waste represents the quickest and most efficient way to fight climate change and save on operating expenses—as eliminated energy waste is the cleanest power source of all, and the cheapest kWh is the one not used.

Also, unlike billing errors, hidden operating and financial waste tends to be recurring; and once wasted—cannot be recovered.

### BRIEF SUMMARY OF THE INVENTION

The invention described herein is a system and method that can systematically analyze the billing data of almost any energy or water company, and automatically filter, diagnose, and valuate the anomalies in the data.

The problem facing the energy management and the utility bill management industries is not unlike that of a well-to-do couple that eats at a different restaurant each day; for example, they may eat at a steakhouse some days, at a French restaurant on other days, at a Chinese restaurant on certain days, and at a McDonald's from time to time; and if in one month the couple's food costs end up being much higher than in prior months, it would appear that there is no way for them to analyze where the anomaly, or anomalies, in their food purchases came from since the only commonality in all of their restaurant bills is in the total cost of each bill.

However, while the above-described problem seems intractable it can be easily solved if the food purchases from the various restaurants are accounted for by food category rather than by menu item. For example, if menu items from the various restaurants are accounted for by fundamental food category such as “entrée”, “appetizer”, “desert”, “alcoholic beverage”, and so on, rather than by “Big Mac”, “Szechuan Chicken”, “New York Strip Steak”, and so on; using this approach, food purchases from any restaurant, anywhere in the world, can be standardized and systematically analyzed.

Similarly, the problem with analyzing energy and water billing data from various utility companies can be easily solved if the billing data from the various energy and water utilities is entered by fundamental cost categories rather than by individual cost factor. For example, if billing items from the various utilities are documented as “energy used”, “peak demand”, “distribution cost”, “commodity cost”, etc. rather than by a myriad of varying charges and surcharges such as “on-peak use”, “Distribution Service”, “Generation”, “Fuel”, “Nuclear Construction Cost Recovery”, “Environmental Compliance Costs”, “Capacity Charge”, “Balancing Congestion Charge”, etc. By adopting an energy accounting method that is based on the fundamental categories of energy and water costs; energy and water purchases from any utility company can be standardized and systematically analyzed.

While the above concept represents the essence of the invention, it is by no means the only inventive concept of the invention. Basically, the invention can be summarized as a system and method for standardizing the analysis of the energy and water cost data of metered energy and water systems by fundamental cost categories—and systematically analyzing how and why the cost data is changing relative to at least one baseline that is based on, or derived from, the system's own preceding records—by decomposing and correlating the monthly rates of change in cost and the monthly rates of change in consumption and prices—and any number of their direct and indirect components and influencers, relative to the at least one baseline—where the energy or water price data is averaged by dividing energy or water cost data by corresponding energy or water consumption data—thereby linking cause to effect and automatically filtering, diagnosing, and valuating the anomalies in the metered energy or water cost data.

More specifically, the invention can be described as an analytics system and method for the systematic analysis of energy and water billing data and the automated filtering, diagnosis, and valuation of anomalies in the data, the system comprising:

at least one storage device configured to store current and recent monthly energy and/or water billing data and previous monthly energy and/or water billing data; the previous monthly energy and/or water billing data are based on, or derived from, energy and/or water billing data that are at least 12 months prior to the current monthly energy and/or water billing data, where the current monthly energy and/or water billing data and the previous monthly energy and/or water billing data fall on the same month of the year; and

wherein the current and recent monthly billing data and the previous monthly billing data comprise monthly energy and/or water use, price, and cost data; and a processor coupled to the storage device, wherein the processor is programmed to:

decompose and synchronize the current and recent monthly energy and/or water use, price, and cost data, and any number of their direct or indirect components and influencers, and the previous monthly energy and/or water use, price, and cost data, and any number of their direct or indirect components and influencers; and

systematically compute the monthly change and rate of change between the current and recent monthly energy and/or water use, price, and cost data, and any number of their direct and indirect components and influencers, relative to corresponding previous monthly energy and/or water use, price, and cost data, and any number of their direct and indirect components and influencers that are based on, or derived from, previous billing data that are at least 12 months in arrears of the current monthly energy and/or water data in order to systematically compare, correlate, and quantify the anomalies in the monthly rates of change in the energy and/or water use and price data and any number of their direct and indirect components and influencers, with anomalies in the monthly rates of change in corresponding energy and/or water cost data; thereby linking cause to effect and automatically filtering, diagnosing, and valuating the anomalies in the data; and

a display coupled to the processor, the display configured to output tabular and/or graphical visualization of the comparisons, changes, and rates of change in the monthly energy and/or water data.

Furthermore, the processor may be programed to derive monthly average energy and/or water price data by dividing monthly energy and/or water cost data by corresponding monthly energy and/or water consumption data; and to derive monthly average energy consumption per day data by dividing monthly energy consumption data by the corresponding number of billing days.

The processor may also be programmed to decompose the reported monthly energy cost data by distribution/delivery company costs as well as by supply/commodity company costs.

Furthermore, the analytics system described above may be supplemented by an expert system or a knowledge library that assigns meaning to the data and enables the interpretation and documentation of the diagnosed anomalies in the data.

### BRIEF DESCRIPTION OF DRAWINGS SHOWING SAMPLE NON-LIMITING EMBODIMENTS

The following detailed description of exemplary non-limiting illustrative embodiments is to be read in conjunction with the drawings of which:

FIG. 1 illustrates a listing of the current difficulties in analyzing utility (energy and water) billing data and filtering, diagnosing, and valuating the anomalies in the data.

FIG. 2 illustrates a listing of the deficiencies in current utility bill management systems and the impact of these deficiencies on the ability of energy users and organizations to eliminate hidden operating and financial waste in energy and water consumption and costs.

FIG. 3(a) illustrates a listing of possible hidden operating waste in energy and water billing data.

FIG. 3(b) illustrates a listing of possible hidden financial waste in energy and water billing data.

FIG. 4 illustrates the proposed solution for uncovering hidden operating and financial waste in utilities' energy and water billing data.

FIG. 5 describes what the invention is.

FIG. 6 describes what the inventive concept is.

FIG. 7 describes the invention's practical advantages.

FIGS. 8(a)-(b) illustrate a system network diagram overview of how the proposed utilities data analysis system can serve as a hub for collecting and processing organizations' utility billing data, uploading the processed information to a central database “in the cloud”, and disseminating the processed information directly to the user.

FIG. 9 is a Component Diagram of the proposed hardware system for analyzing the utility billing data for the user.

FIG. 10 is a Component Diagram of the proposed “cloud” storage system for providing accessibility to the processed data to the user.

FIG. 11 illustrates a non-limiting example of a Dominion Energy electric bill for a residential customer.

FIGS. 12(a)-(b) illustrate a non-limiting example of a two-part Georgia Power electric bill.

FIGS. 13(a)-(d) illustrate a non-limiting example of a four-part Pepco electric distribution bill.

FIGS. 14(a)-(b) illustrate a non-limiting example of a two-part Constellation electric supply, or commodity, bill.

FIG. 15 describes the fundamental cost structure of most energy and water utility bills.

FIG. 16 describes the fundamental cost structure of the Dominion residential electric bill of FIG. 11 decomposed, or broken down, by cost component.

FIG. 17 describes the fundamental cost structure of the Georgia Power electric bill of FIGS. 12(a)-(b) decomposed, or broken down, by cost component.

FIG. 18(a) describes the fundamental cost structure of the Pepco electric distribution bill of FIGS. 13(a)-(d) decomposed, or broken down, by cost component.

FIG. 18(b) describes the fundamental cost structure of the Constellation electric supply, or commodity, bill of FIGS. 14(a)-(b) decomposed, or broken down, by cost component.

FIG. 19 describes the fundamental cost structure of a simplified and standardized electricity bill decomposed, or broken down, by universal cost components.

FIG. 20 illustrates a non-limiting System Process Diagram of how the utility data analysis system performs automated actions based on the data that was entered into the system.

FIG. 21(a) illustrates a non-limiting exemplary data entry and processing form.

FIG. 21(b) illustrates another non-limiting exemplary data entry and processing form.

FIG. 21(c) illustrates yet another non-limiting exemplary data entry and processing form.

FIG. 22(a) illustrates a non-limiting exemplary automated cost filtering method.

FIG. 22(b) illustrates an enhanced non-limiting exemplary automated cost filtering method.

FIG. 22(c) illustrates yet another enhanced non-limiting exemplary automated cost filtering method.

FIGS. 23(a)-(b) illustrate a non-limiting exemplary automated cost diagnostic method for electricity accounts.

FIG. 24 illustrates a non-limiting exemplary analysis of levied late payment penalties and special charges and credits for electricity accounts.

FIG. 25 illustrates a non-limiting exemplary analysis of recorded payment transactions for electricity accounts.

FIGS. 26(a)-26(b) illustrate an enhanced non-limiting exemplary automated cost diagnostic method for electricity accounts.

FIGS. 27(a)-27(d) illustrate yet another enhanced non-limiting exemplary automated cost diagnostic method for electricity accounts.

FIGS. 28(a)-28(c) illustrate a non-limiting exemplary automated cost diagnostic method for gas accounts.

FIGS. 29(a)29(d) illustrate a non-limiting exemplary automated cost diagnostic method for water accounts.

FIG. 30 illustrates a non-limiting exemplary method for automated and integrated utility cost roll-up for multiple utility accounts.

FIG. 31 illustrates a non-limiting exemplary method for automated and integrated utility cost drill-down for multiple utility accounts.

### DETAILED DESCRIPTION OF NON-LIMITING EXAMPLE EMBODIMENTS

Before delving into a detailed explanation of the non-limiting exemplary embodiment of the disclosed invention, a detailed explanation is provided regarding the difficulties current utility management methods have in analyzing energy and water billing data, the major deficiencies of the current art, and the resulting hidden operating and financial waste. In addition, the proposed solution to the problem, its inventive concept, and its practical advantages to the user are also presented.

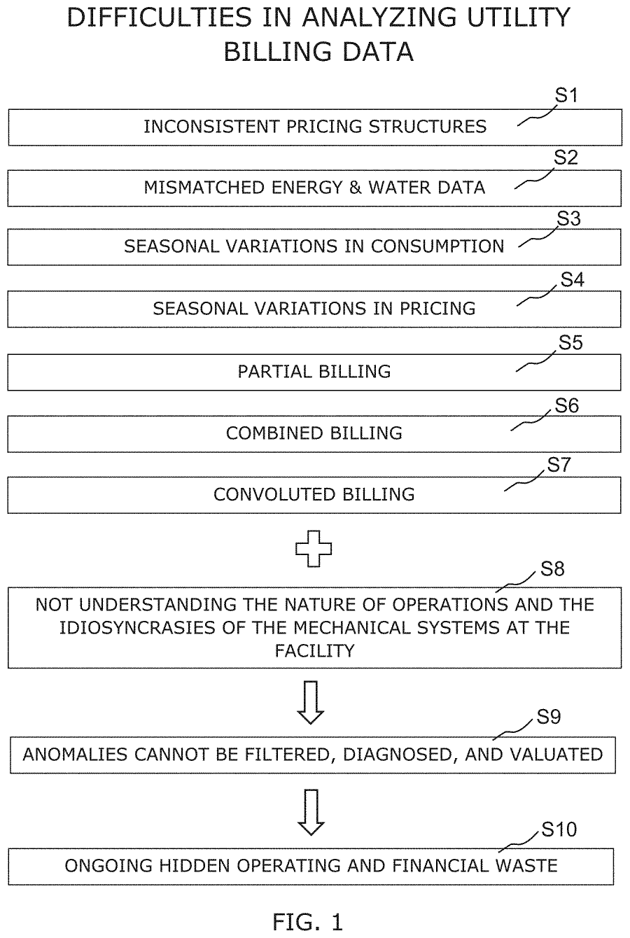

FIG. 1 illustrates the difficulties that the utility bill management industry has in analyzing utility data. These include (S1) inconsistent pricing structures that vary by utility company and by rate schedule; (S2) mismatched energy and water data that often start on different days of the month and frequently include varying number of billing days from one month to another and from one year to another; (S3) seasonal variations in energy and water consumption that reflect the use of cooling systems in the summer and heating systems in the winter; (S4) seasonal variations in pricing that reflect the varying costs of fuel for the utilities—especially when there are wide swings in weather temperatures; (S5) partial billing by the utilities when, for example, the commodity supplier of electricity or gas does not provide the billing company (usually the company that owns the meter and distributes the commodity) with their billing data in a timely manner to be included in the current month's utility bill; (S6) combined billing by the utilities when, for example, they cannot read the meter in a particular month, and issue a combined bill in a subsequent month; (S7) convoluted billing by the utilities when, for example, they issue a bill with the “distribution” part of the bill covering a different number of months than the “commodity” part of the bill; or when utility bills covering several months are cancelled for one reason or another and re-issued with different billing data. This procedure represents a special challenge to the customer, and to the utility bill management company, as several months' worth of prior payments for bills that have been cancelled have to be accounted for when verifying the accuracy of the new combined bill; and finally (S8) the inability of utility bill management companies to assign meaning to the bills that they are analyzing without understanding the function and the layout of the mechanical systems of the facility for which they are analyzing the utility bills. For example, some facilities feed energy and/or water to other facilities while some facilities get fed partially with energy or water from neighboring facilities. In addition, without understanding whether the bill that they are analyzing is for a hospital, a warehouse, or an office building, it is hard for a utility bill management company to make any sense of the billing data that it is “analyzing”.

The above-described problems and idiosyncrasies make it practically impossible for conventional utility bill management methods to filter, diagnose, and valuate the anomalies in the data—resulting in ongoing hidden operating and financial waste.

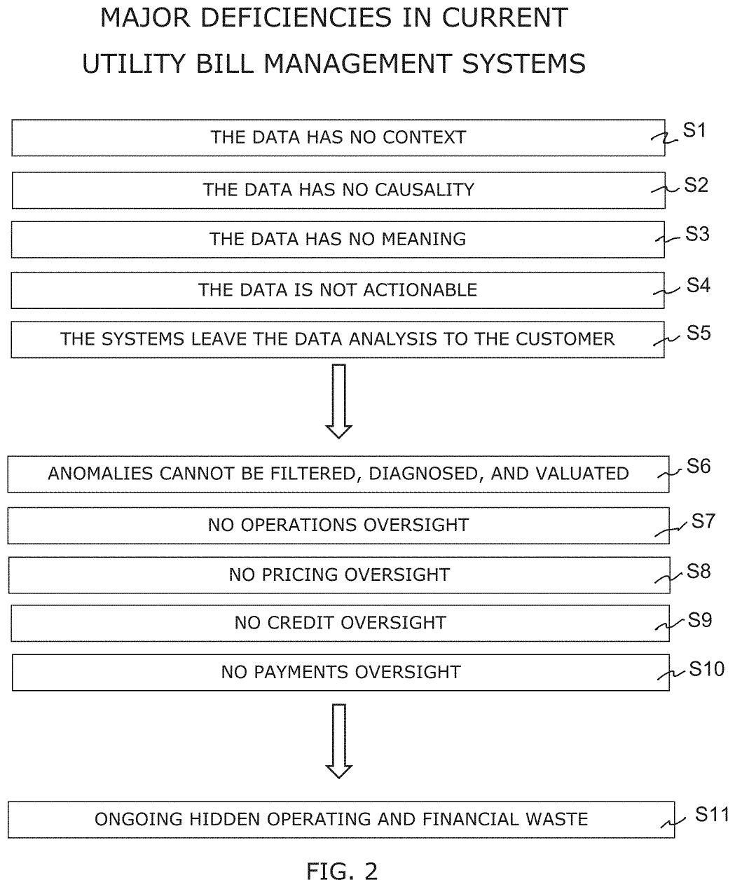

FIG. 2 illustrates the major deficiencies in current utility bill management systems. These include item (S1) the data has no context; by focusing on billing accuracy at the exclusion of seasonal variations in consumption and pricing, and without understanding what the bill that is being analyzed represents, important operational, and even financial anomalies, may be overlooked; item (S2) states that the data has no causality; this is because without simultaneously analyzing the changes in cost and the changes in the key drivers and influencers of energy and water costs, current utility bill management systems cannot extract causality from the data; and item (S3) points out that as a result of Items (S1) and (S2), the data has no meaning; and this is especially true because current utility bill management methods do not bother understanding what the energy and water bills that they are analyzing represent. As a result, item (S4) indicates that the data is not actionable; in fact, the key benefits of current utility bill management methods are computational accuracy, energy accounting, and utility budgeting—none of which is actionable. Items (S5) concludes that current utility bill management systems leave the data analysis to the customer; and that becomes obvious considering the deficiencies discussed above.

Item (S6) asserts that as a result of Items (S1) through (S5) above, anomalies in energy and water billing data cannot be filtered, diagnosed, and valuated—resulting in (S7) no operational oversight; (S8) no pricing oversight; (S9) no credit oversight—credit oversight here means the ability to determine if earned credit has being provided (for example, credit for customers that maintain their own high voltage electricity transformers and credit for water evaporated at cooling towers that does not enter the sewer system); and (S10) no payments oversight—and that means the inability to determine if payments that were made by the customer have been accurately credited by the subject utility company. All the above deficiencies result in (S11) ongoing hidden operating and financial waste.

In this respect, several companies that process utility bills either as a software or as a service have been researched. These companies typically fall into several categories: The first category includes utility bill management companies; companies that fall under this category include enel X (www.enelx.com), Siemens (www.siemens.com), and MidAmerican Energy Services (www.midamericanenegyservices.com). These companies tend to be exceptionally large with the ability to pay their customers' monthly utility bills for them in a timely manner to help them avoid incurring late payment penalties. These companies do not claim to analyze their customers' energy and water data, and the focus of their utility bill management business is on streamlining the bill payment process and reporting the billing data.

A second category includes energy dashboard companies. These companies do not claim to analyze their customers' utility bills or utility billing data. The primary focus of these companies is on real-time energy monitoring, data collection, and integration. Companies that fall under this category include eSight Energy (www.esightenergy.com), BuildinglQ (www.buildingiq.com); Wattics (www.wattics.com), aquicore (www.aquicore.com), and Mach Energy (www.machenergy.com) among others. Most of these companies specialize in digitizing and submetering their customers' energy consumption.

A third category includes companies that provide utility bill tracking and auditing software and services. Some these companies include Ardem incorporated (www.ardem.com), Abraxas Energy Consulting (www.abraxasenergy.com), and Cost Control Associates (www.costcontrolassociates.com. While these companies provide utility bill auditing and analysis services, their focus in on auditing and analyzing their customers' utility bills—not their utility data. These companies do not have the capability of analyzing their customers' utility data.

A fourth category is a unique company by the name of Urjanet (www.urjanet.com. This company specializes in enabling customers to have easy access to their utility data—without having the capability to analyze the provided data for their customers.

A fifth category is a company by the name OPower—which is now a subsidiary of Oracle corporation (www.oracle.com) This company provides software-as-a-service customer engagement platform for utilities. Basically, its software enables utility users to compare their energy consumption to that of their neighbors as a motivator to reduce their energy consumption—without providing any actionable information that would enable them to do so.

What sets the invention described herein apart from the concept of all existing utility bill management, utility bill auditing, utility data tracking, energy monitoring, and utility data access companies is that the inventive concept of the invention described herein provides energy users with actionable information that actually enables them to eliminate hidden operating and financial waste in their energy and water consumption and costs—as it occurs—by analyzing how the changes in their energy and water billing data relate to one-another. None of the companies mentioned above use a similar concept in the conduct of their utility management businesses.

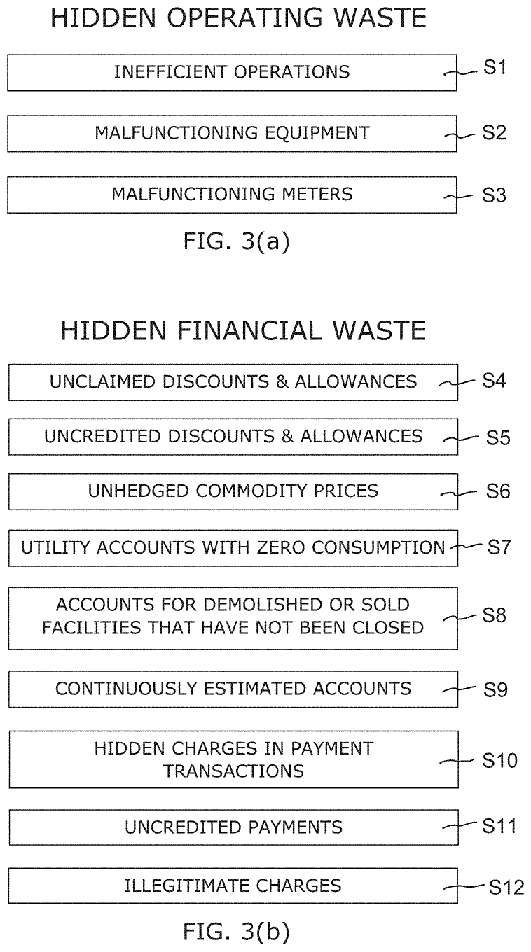

FIG. 3(a) lists the types of hidden operating waste that the invention helps uncover. These include (S1) inefficient operations such as excessive consumption, erratic consumption, electric demand spikes, and high off-peak energy consumption; (S2) malfunctioning equipment such as water leaks and steam leaks; and (S3) malfunctioning and broken meters.

FIG. 3(b) lists the types of hidden financial waste that the invention helps uncover. These include (S4) unclaimed discounts and allowances; (S5) uncredited discounts and allowances; (S6) unhedged commodity prices; (S7) open utility accounts with zero reported consumption over a long period of time; (S8) open utility accounts related to demolished or sold facilities that have not been closed by the customer; (S9) continuously estimated accounts; (S10) hidden charges in past due amounts; (S11) uncredited payments; and (S12) illegitimate charges.

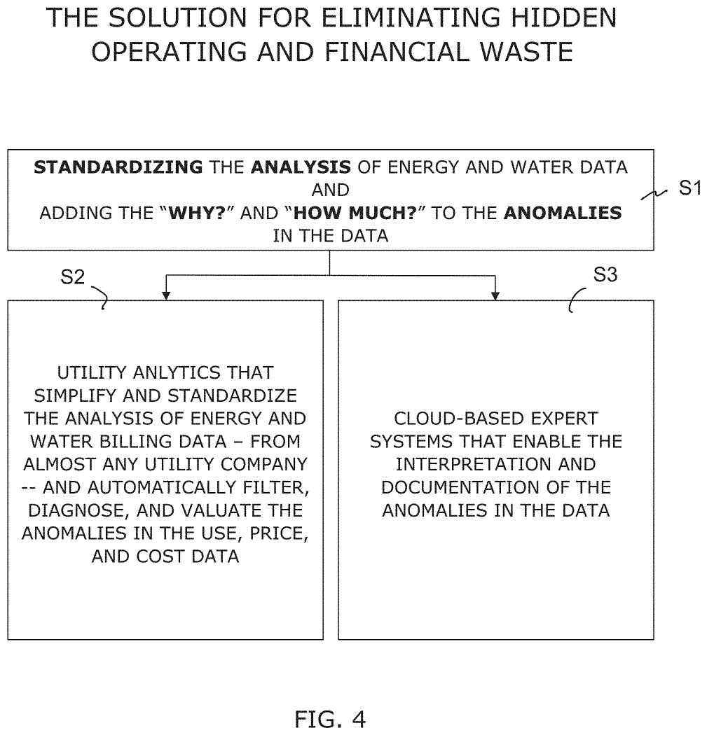

FIG. 4 states the solution that the disclosed invention provides regarding the elimination of hidden operating and financial waste in energy and water consumption and costs. The solution (S1) provides for standardizing the analysis of energy and water data by diagnosing and valuating the anomalies in the billing data. This includes (S2) providing analytics that simplify and standardize the analysis of energy and water billing data from practically any utility company and automatically filter, diagnose, and valuate the anomalies in the use, price, and cost data; and (S3) providing cloud-based expert systems that enable the interpretation and documentation of the anomalies in the data.

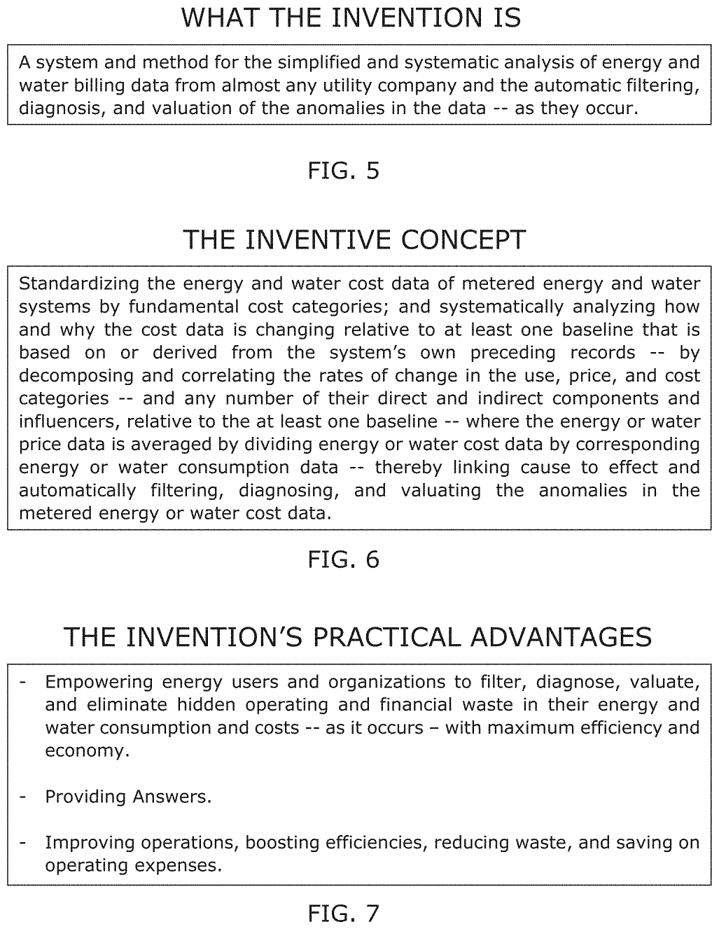

FIG. 5 states that the invention is a system and method for the simplified and systematic analysis of energy and water billing data from almost any utility company and the automatic filtering, diagnosis, and valuation of the anomalies in the data—as they occur.

FIG. 6 states that the inventive concept of the invention is standardizing the energy and water cost data of metered energy and water systems by fundamental cost categories; and systematically analyzing how and why the cost data is changing relative to at least one baseline that is based on or derived from the system's own preceding records—by decomposing and correlating the rates of change in the use, price, and cost categories—and any number of their direct and indirect components and influencers, relative to the at least one baseline—where the energy or water price data is averaged by dividing energy or water cost data by corresponding energy or water consumption data—thereby linking cause to effect and automatically filtering, diagnosing, and valuating the anomalies in the metered energy or water cost data.

FIG. 7 states the invention's practical advantages which are a) empowering energy users and organizations to filter, diagnose, valuate, and eliminate hidden operating and financial waste in their energy and water consumption and costs—as it occurs—with maximum efficiency and economy; b) providing answers; and c) improving operations, boosting efficiencies, reducing waste, and saving on operating expenses.

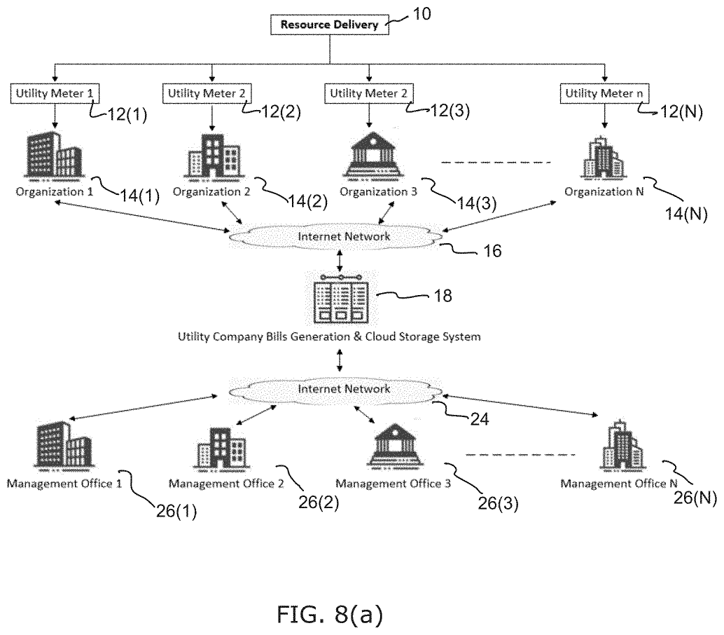

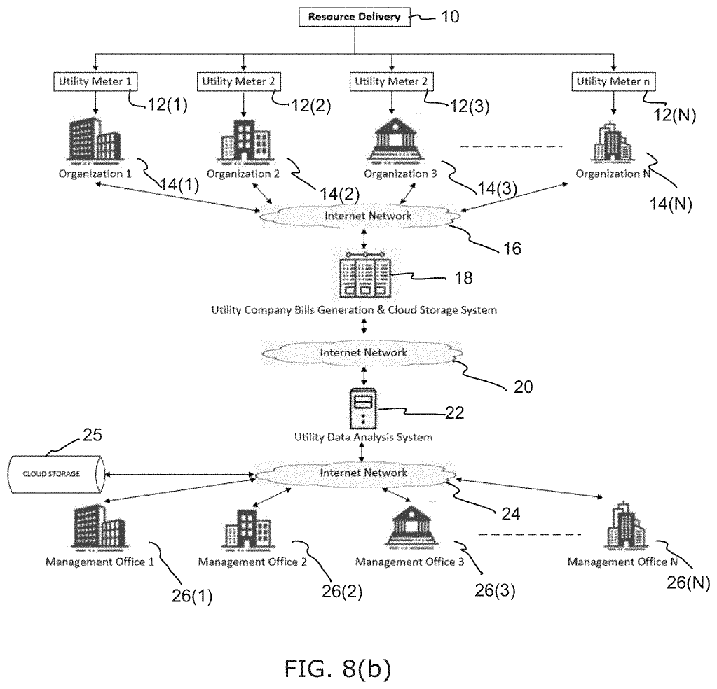

FIG. 8(a) illustrates the status of a non-limiting exemplary utility bill generation and dissemination process; resource delivery 10 delivers resources such as energy and/or water to a facility or facilities 14(1), 14(2), 14(3) . . . to 14(N). In certain instances, one facility may be provided; however, in non-limiting example implementations, a resource delivery may deliver resources to a plurality of facilities including a plurality of meters, as well as a plurality of facility management entities and/or end users.

The resources delivered are measured by meters 12(1), 12(2), 12(3) . . . 12(N), or another utilities-measuring device. Information relating to the usage of these resources is sent from the facilities to (and/or retrieved by) a non-limiting exemplary utility company bill generation and cloud storage computer system 18 via internet network 16.

The generated utility bills may then be accessed by a management office or end user 26(1) . . . 26(N) via internet network 24 either by being pushed to the management office or end user 26(1) . . . 26(N) through email or by being accessed directly by the management office or end user 26(1) . . . 26(N) via network 24.

FIG. 8(b) illustrates how a non-limiting exemplary utility billing data analysis system 22 can access and collect utility bills directly from an exemplary utility company bills generation and cloud storage system 18 via network 20, performs specific data filtering, diagnosis, and valuation processes on the data to uncover hidden operating and financial waste as described by the invention herein, stores a copy of the processed information in a cloud-based storage system 25 via internet network 24, for direct access by the end user/users 26(1) . . . 26(N), as well as delivers a copy of the processed information directly to the end user/users 26(l) . . . 26(N) via email through internet network 24.

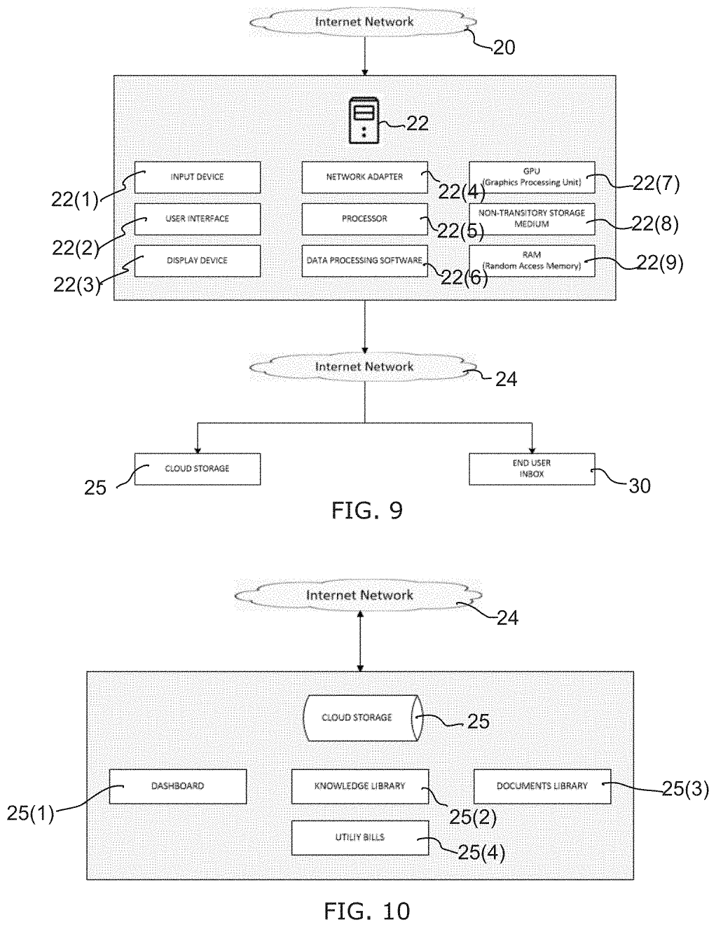

FIG. 9 illustrates a non-limiting exemplary utility billing data analysis system 22; the exemplary system comprising an input device 22(1), a user interface 22(2), a display device 22(3), a network adapter 22(4), a processor 22(5), a graphic processing unit 22(7), a non-transitory storage medium 22(8), random access memory 22(9), and data processing software 22(6). The system may be connected to the internet through internet connection 20 and/or internet connection 24 to access data from a utility company bill generation and cloud storage system 18; as well as to store the processed data to cloud storage 25; and to deliver a copy of the processed information to end users' inboxes 30.

FIG. 10 illustrates a non-limiting exemplary cloud storage system 25 connected to the internet through internet network 24; the exemplary cloud storage system comprising a software dashboard 25(1); a knowledge library 25(2); a documents library 25(3); and utility bills storage medium 25(4).

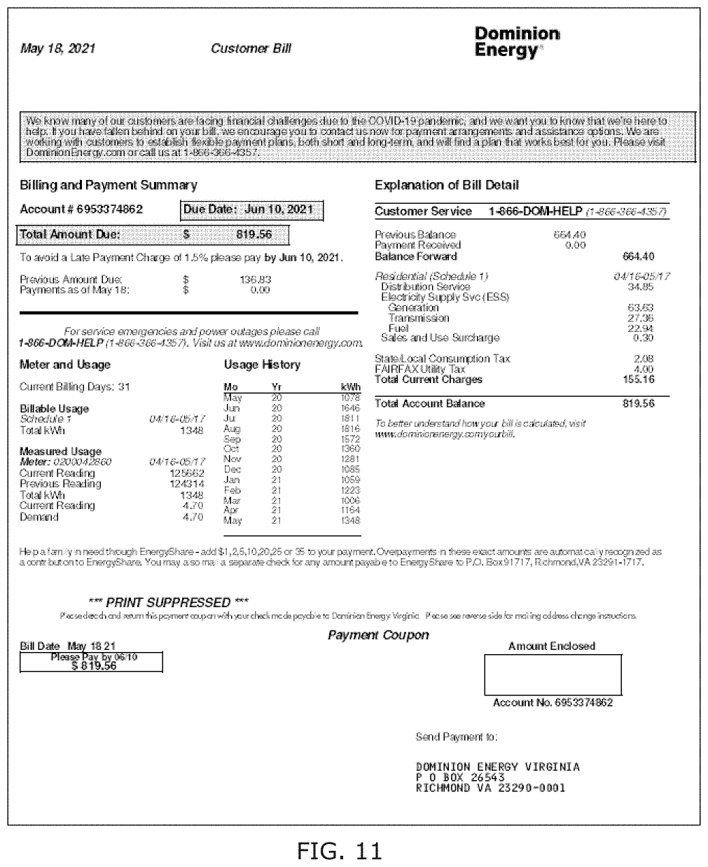

FIG. 11 illustrates an exemplary electricity bill from Dominion Energy.

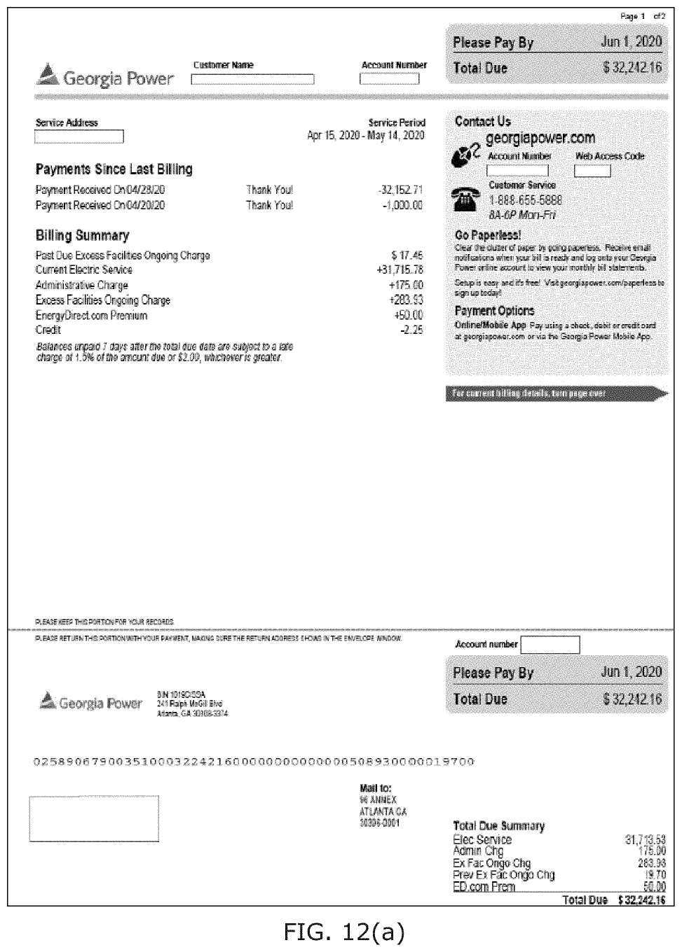

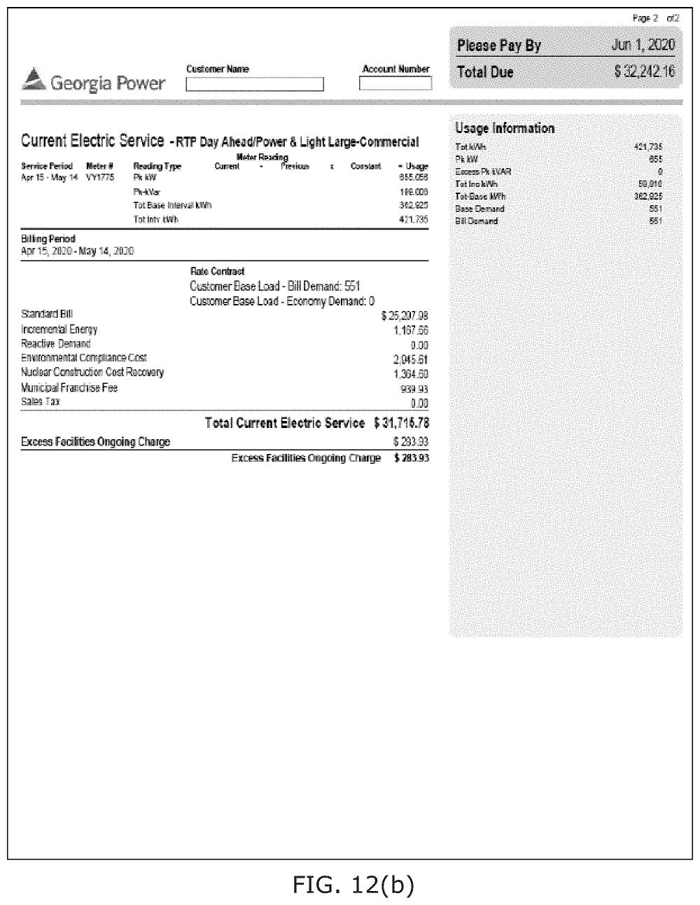

FIGS. 12(a)-12(b) illustrate a 2-page exemplary electricity bill from Georgia Power.

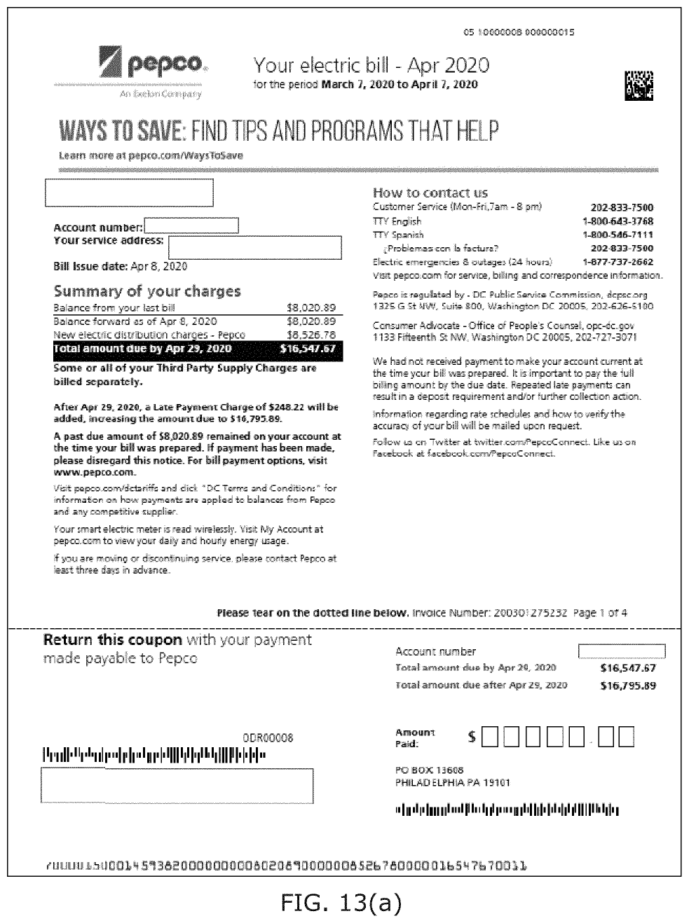

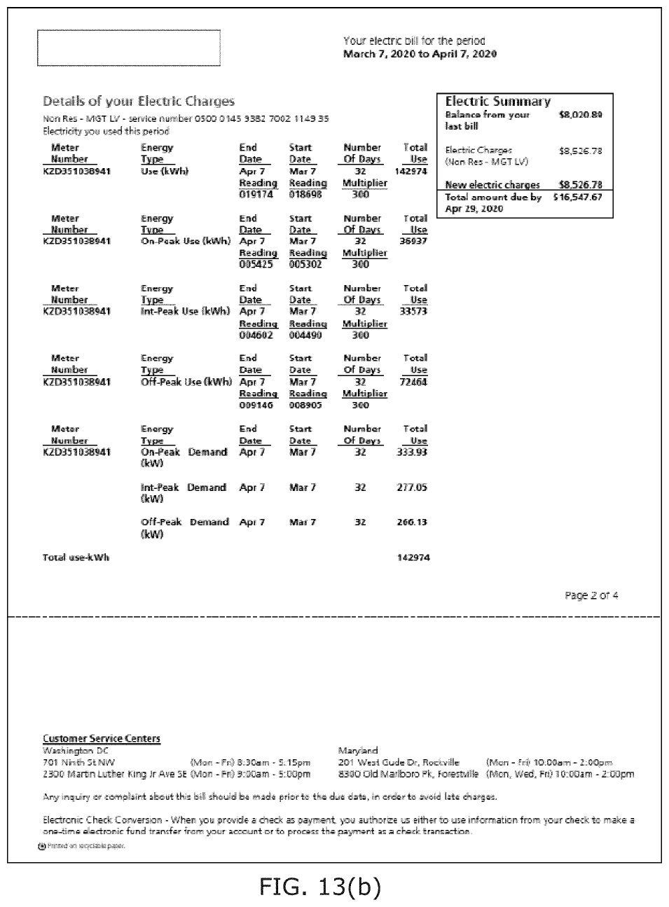

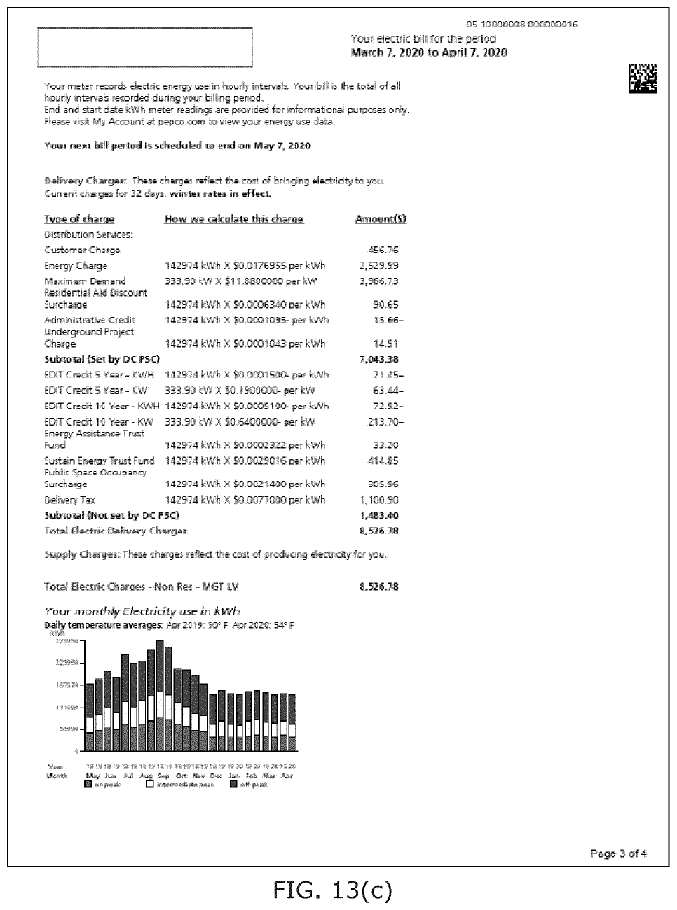

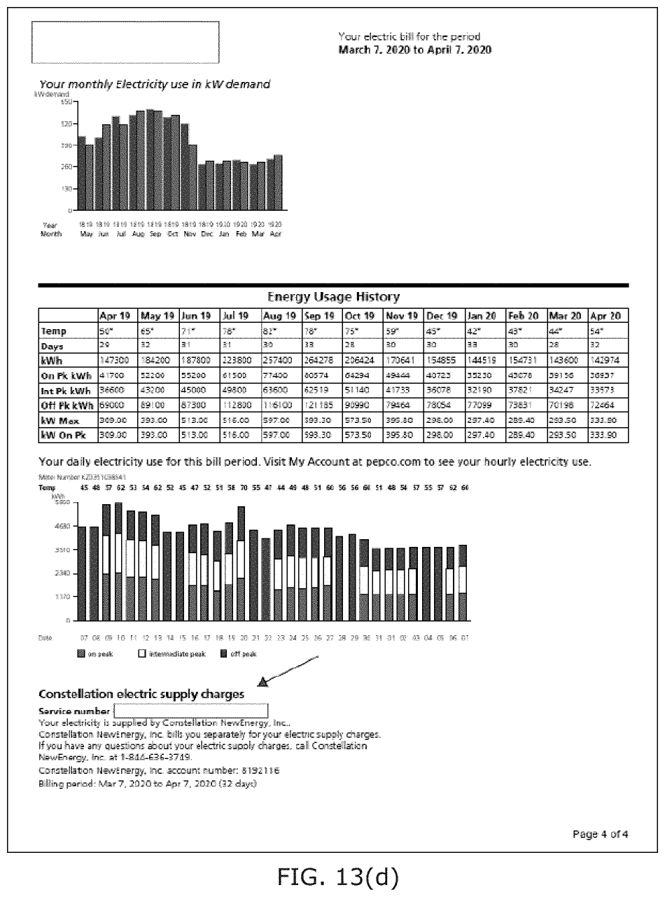

FIGS. 13(a)-13(d) illustrate a 4-part exemplary electricity bill from Pepco (Potomac Electric Power Company) that is limited to electricity distribution costs.

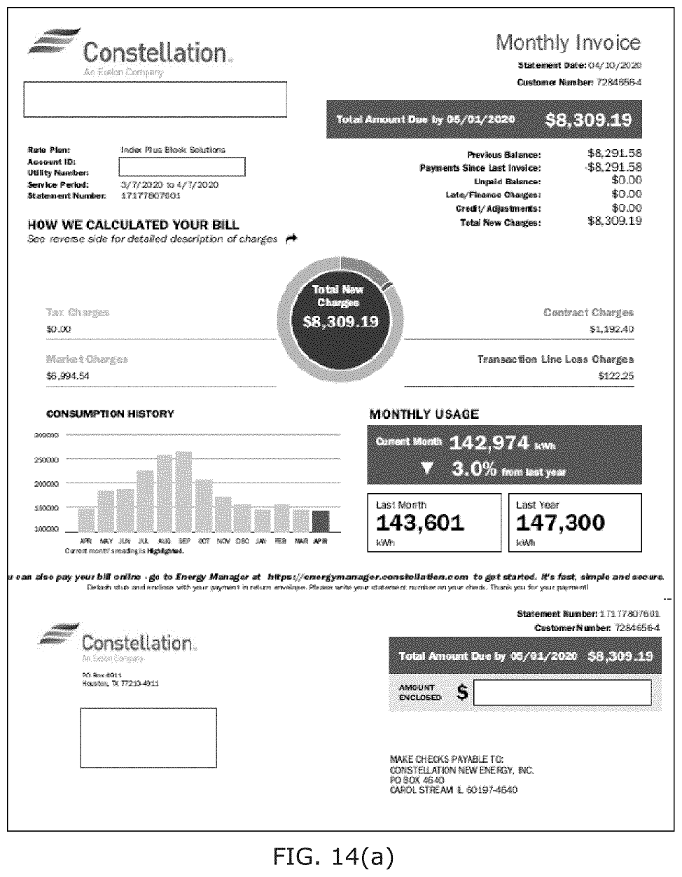

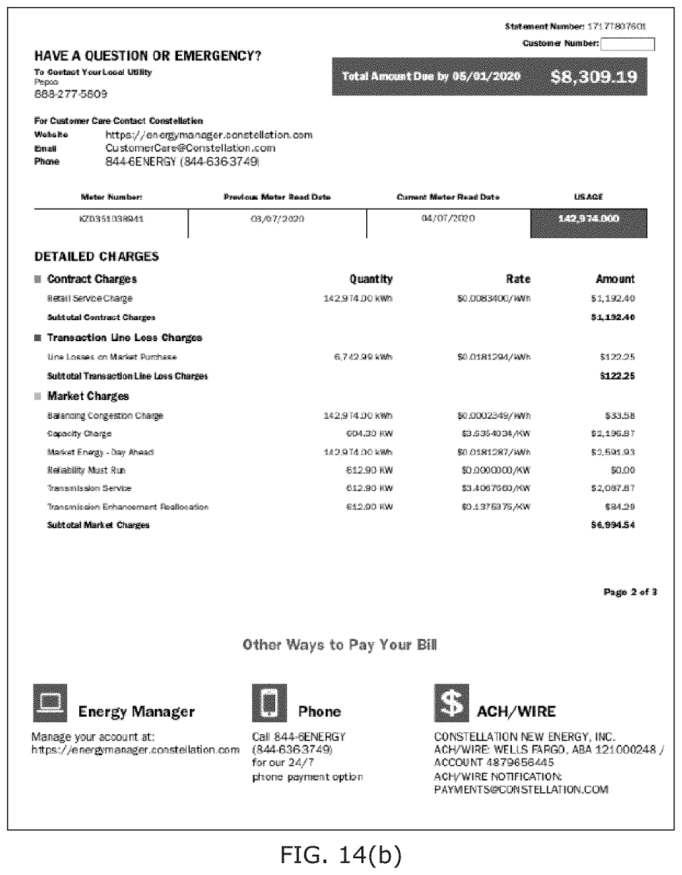

FIGS. 14(a)-14(b) illustrate a 2-part exemplary electricity bill from Constellation Energy (an electricity provider and gas supplier company) that is limited to commodity and transmission costs.

The purpose of providing the above-described utility bills is to demonstrate that despite having radically different pricing structures, all the presented utility bills share a common fundamental pricing structure which can be used to standardize and automate the analysis of their billing data.

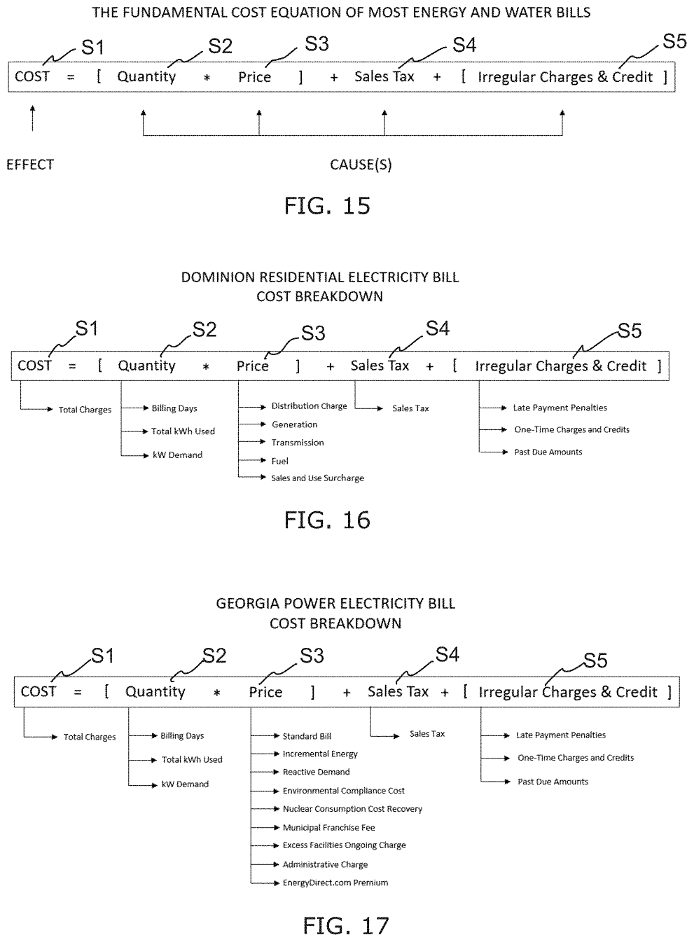

FIG. 15 illustrates the fundamental energy and water cost structure of practically any utility company. Billed cost (S1) of practically any utility company is the product of multiplying the consumed energy and/or water quantity (S2) by a price (S3); adding a sales tax (S4); and irregular charges and credits (S5)—such as late payment penalties or special one-time credits. FIG. 15 also indicates that Cost (S1) is the resulting “effect” of “Causes” (S2), (S3), (S4), and (S5).

FIG. 16 illustrates the cost breakdown of the Dominion Energy electricity bill of FIG. 11. In this exemplary electricity bill, Dominion Energy has itemized its pricing structure into the following components: a Distribution charge, a generation charge, a transmission charge, a fuel charge, and sales and use surcharge (a surcharge is typically a tax that is levied by a local government on a utility company which is passed on by the utility company to its customer). The difference between a surcharge and a sales tax is that a surcharge is typically a tax on the utility company while a sales tax is typically a tax on the utility company's customers). The practical difference is that all utility company customers must pay a surcharge, while tax-exempt utility customers, such as churches, universities, government entities and the like, do not have to pay sales taxes.

FIG. 17 illustrates the cost breakdown of the Georgia Power electricity bill of FIGS. 12(a)-(b). In this exemplary electricity bill, Georgia Power has itemized its pricing structure into the following components: Standard Bill, Incremental Energy, Reactive Demand, Environmental Compliance Cost, Nuclear Consumption Cost Recovery, Municipal Franchise Fee, Excess Facilities Ongoing Charge, Administrative Charge, and EnergyDirect.com Premium.

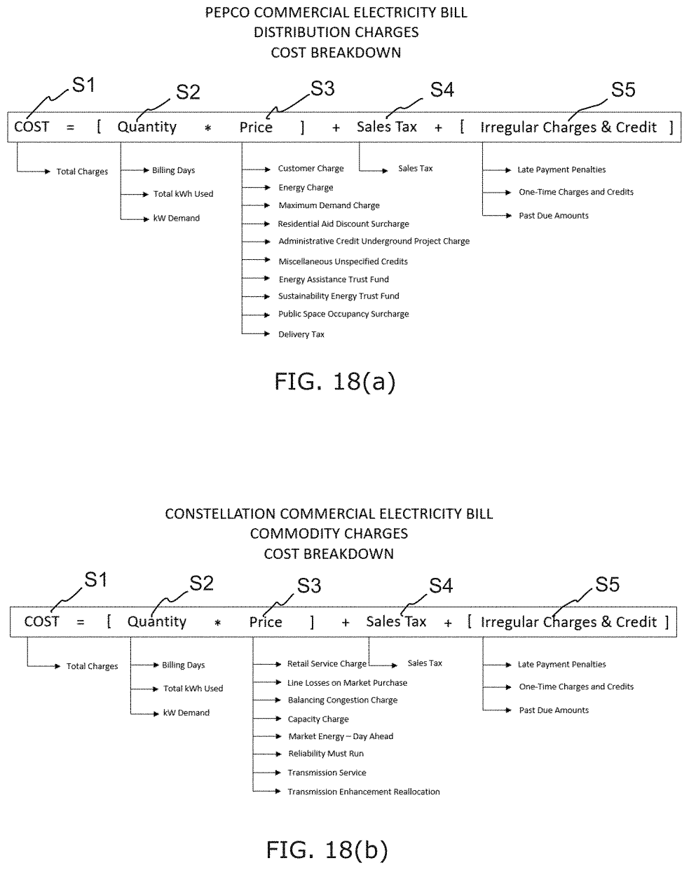

FIG. 18(a) illustrates the cost breakdown of the Pepco electricity bill of FIGS. 13(a)-(d). This bill only covers the “distribution” part of the electric service for a Washington D.C. facility; the “commodity” part of the electric service is being provided separately by Constellation Energy. In this exemplary Pepco electricity bill, Pepco has itemized its pricing structure into the following components: Customer charge, Energy Charge, Maximum Demand Charge, Residential Aid Discount Surcharge, Administrative Credit Underground Project Charge, Miscellaneous Unspecified Credits, Energy Assistance Trust Fund, Sustainability Energy Trust Fund, Public Space Occupancy Surcharge, and Delivery Tax.

FIG. 18(b) illustrates the cost breakdown of the Constellation electricity bill of FIGS. 14(a)-(b). This bill covers the “commodity” portion of the electric service for a Washington D.C. facility. In this exemplary electricity bill, Constellation has itemized its pricing structure into the following components: Retail Service Charge, Line Losses on Market Purchase, Balancing Congestion Charge, Capacity Charge, Market Energy—Day Ahead, Reliability Must Run, Transmission Service, and Transmission Enhancement Relocation.

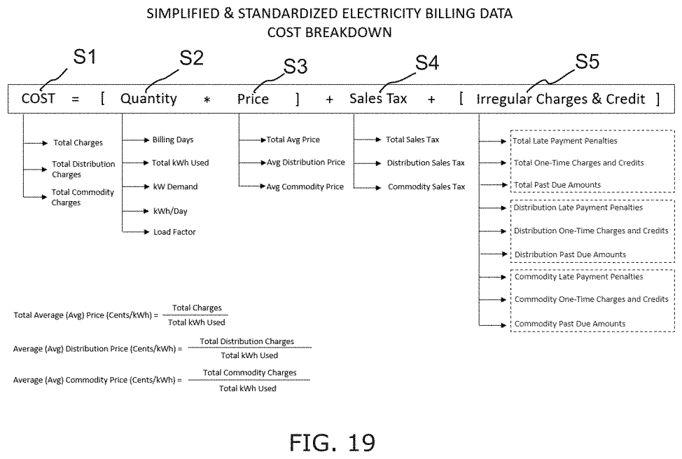

FIG. 19 demonstrates how the cost structures of the utility bills of Dominion Energy, Georgia Power, Pepco, and Constellation—which encompass FIG. 11 to FIG. 14(b) can be standardized into a unified universal cost structure simply by averaging the pricing structure of each of the individual utility bills. This can be accomplished simply by dividing the total energy cost of each utility bill by the total energy consumption stated on that bill—without having to know anything about the pricing structure that is detailed on that bill. This process can be further enhanced by decomposing the energy price into an average distribution price and an average commodity price using the same process described above (dividing total distribution cost by total energy consumption and dividing total commodity cost by total energy consumption). Furthermore, the energy consumption of each energy bill can be standardized and dividing the total reported energy consumption on each bill by the total number of billing days. This averaging process would overcome any mismatching in the number of billing days from one billing period to another. Using the price and use averaging processes described above, the billing data of energy and water bills from any utility company can be standardized—and if they can be standardized, their data can be automatically filtered, quantified, and diagnosed using the non-limiting exemplary processes described in the following figures.

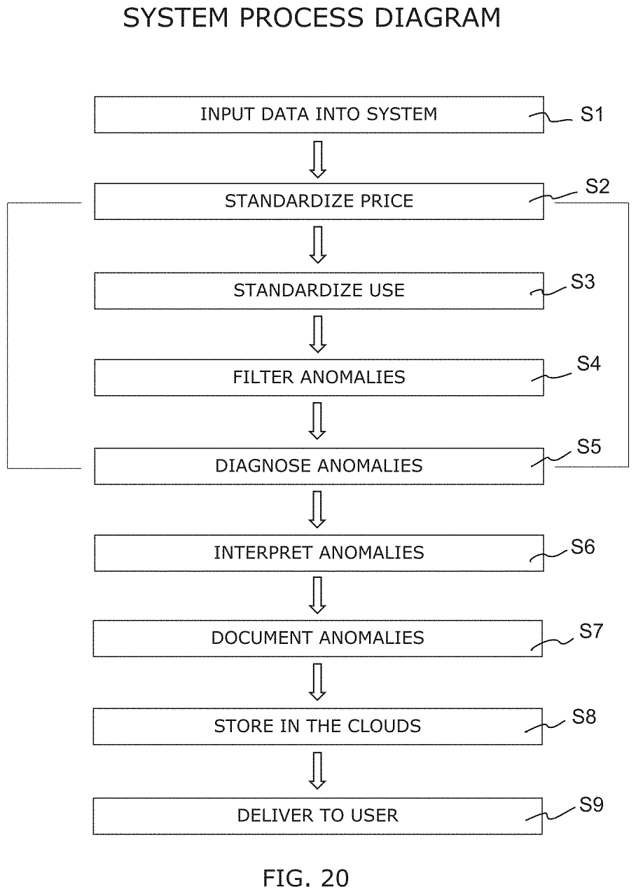

FIG. 20 illustrates the processing steps that are involved in the systematic analysis of utility billing data from almost any utility company, and the automatic filtering, diagnosis, and valuation of the anomalies in the data. These include (S1) inputting utility data from almost any utility company into simplified and standardized data entry forms; (S2) standardizing the pricing data; (S3) standardizing the commodity (energy/water) consumption (quantity) data; (S4) filtering the anomalies in the data; (S5) diagnosing the anomalies in the data; (S6) interpreting the anomalies in the data; (S7) documenting the anomalies in the data; (S8) storing the processed information in the clouds for direct access by users; and (S9) delivering the processed information directly to users' inboxes.

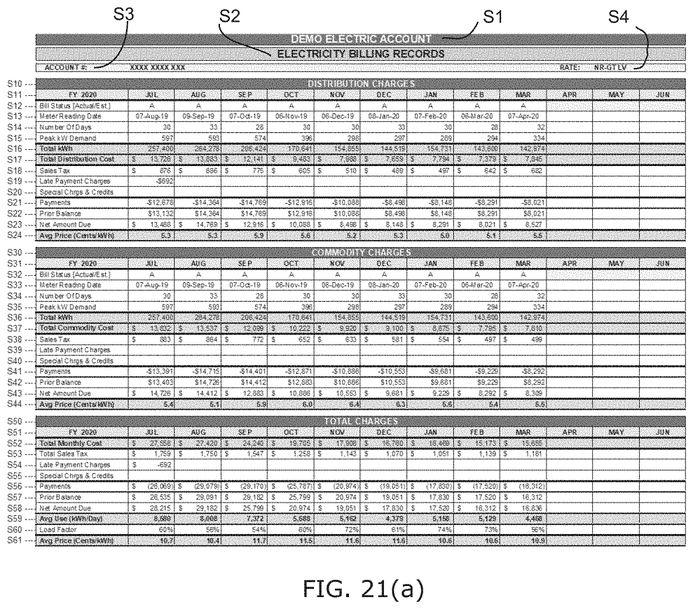

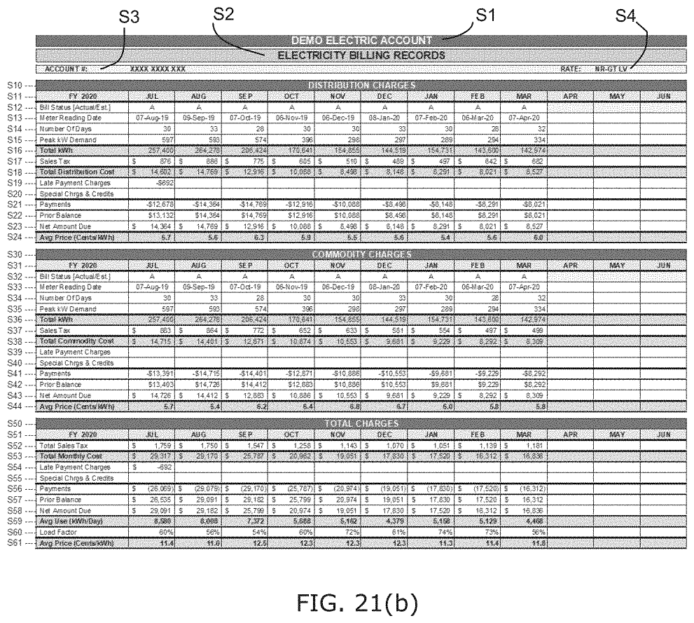

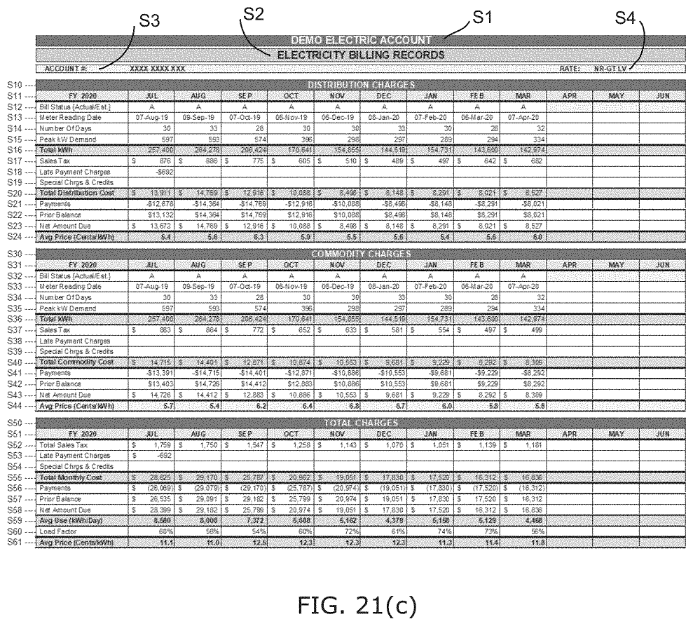

FIG. 21(a) illustrates a simplified and standardized non-limiting exemplary utility billing analysis data entry form. The form includes (S1) facility name; (S2) type of commodity data entry form (in this case it is a data entry form for electricity accounts); (S3) the account number given by the utility company; (S4) the applied rate schedule; (S10) identifies that the entered data is for the distribution part of the electric bill; (S11) identifies the fiscal year for which the data is being entered and the months for which the data is to be entered; (S12) identifies the bill status for each monthly bill (Typically “A” indicates an actual bill, and “E” indicates an estimated bill); (S13) indicates the meter reading date; (S14) indicates the number of billing days covered by the bill; (S15) indicates the monthly peak kW demand; (S16) indicates the total number of kWh used during the billing month; (S17) indicates the total distribution cost covered by the monthly bill; (S18) indicates the amount of sales tax covered; (S19) indicates the amount of late payment charges incurred or credited (a minus sign indicates that a credit or refund had been given on a prior late payment penalty or penalties); (S20) indicates any special (usually one-time) charges incurred or special credits given; (S21) indicates the monthly amount of money paid to the utility; (S22) indicates the prior balance incurred by the account; (S23) indicates the net amount due; and (S24) automatically computes the average price paid for monthly electricity distribution by dividing the total distribution cost (S17) by the total kWh used (S16).

Items (S30) through (S44) repeat the same process described above, but for the commodity charges of the bill.

Items (S50) through (S61) combine elements from the distribution part of the bill with elements from the commodity part of the bill and derives the total average price for the commodity (energy or water) (S61) as well as the average kWh consumption per day (S59). It is important to note in this respect, that in this data entry form, the computed average price for distribution (S24) and commodity (S44) do not factor in the sales tax amounts, the late payment charges, and the special charges and credits because these amounts were not included in the total monthly distribution costs (S17) and total monthly commodity costs (S37). Consequently, the total monthly average price (S61) does not include the monthly sales tax into the total monthly average electricity price.

FIG. 21(b) is a very similar form to the data entry form of FIG. 21(a) with the only exception being that the computed average price for distribution (S24) and commodity (S44) do factor in the monthly sales tax amounts because these amounts were included in the total monthly distribution costs (S18) and total monthly commodity costs (S38). Consequently, the total monthly average price (S61) also includes the monthly sales tax into the total monthly average electricity price.

FIG. 21(c) is also a very similar form to the data entry form of FIG. 21(a) with the only exception being that the computed average price for distribution (S24) and commodity (S44) do factor in not only the monthly sales tax amounts, but also the late payment charges and the special charges and credits because these amounts were included in the total monthly distribution costs (S20) and total monthly commodity costs (S40). Consequently, the total monthly average price (S61) also includes not only the monthly sales tax, but also the late payment charges and the special charges and credits into the total monthly average electricity price.

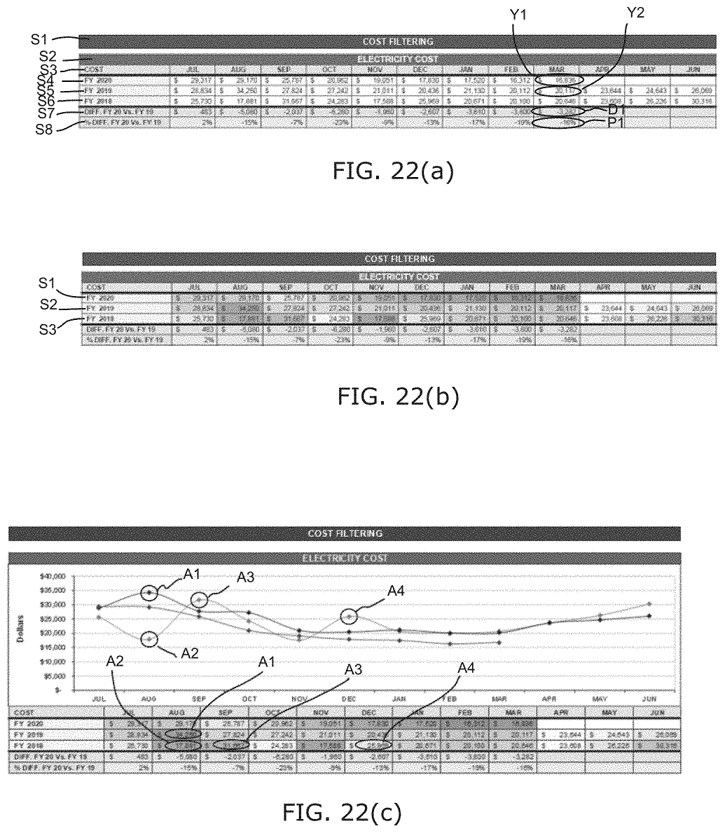

FIG. 22(a) illustrates an exemplary non-limiting implementation of the automated filtering process of the disclosed invention. In this example, anomalies in the monthly billing data of a metered electricity account are filtered by comparing how the monthly data is changing in current and recent months of the current fiscal year relative to a baseline that is based on, or derived from, the metered electricity account's own monthly billing data from the prior year. The comparisons are made by computing the change and the rate of change in the monthly billing data from the current fiscal year's monthly data to the prior fiscal year's monthly data. For example, in FIG. 22(a) The March 2020 cost data of the current year (Y1) is $16,836, while the March 2019 cost data of the prior year (Y2) is $20,117 resulting in a cost reduction (D1) of approximately $3,2812 and a rate of change (P1) of about 16% reduction from the prior year.

In this exemplary non-limiting implementation, a second baseline from another prior year has been added to provide a second frame of reference to the current year's data in case the prior year's data was abnormal for some reason. In this example, the current year's data is abnormal because of the Covid-19 pandemic. This is reflected in the fact that every month of the FY 2020 fiscal year shows lower operating costs than the prior year due to substantial reductions in facility operations during the pandemic.

FIG. 22(b) illustrates an added enhancement to the filtering method of FIG. 22(a) by dynamically ranking the yearly cost data (S1), (S2), and (S3) using a color-coding scheme that ranks the data using different colors for each order of magnitude—instantly flagging out-of-range anomalies in the data.

FIG. 22(c) illustrates yet another enhancement to the filtering method of FIG. 22(b) by providing an automated graphical representation of the data that instantly and clearly visualizes the out-of-range anomalies in the data relative to both prior months and prior years. For example, using this technique, data anomalies (A1), (A2), (A3) and (A4) clearly and unequivocally stand out from the rest of the data.

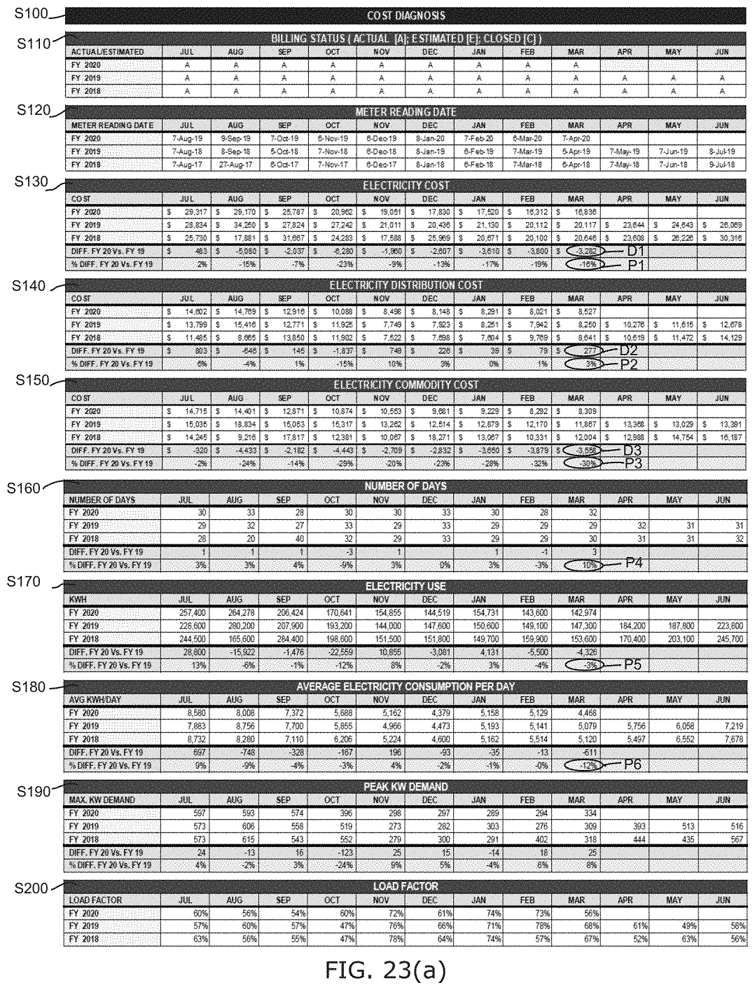

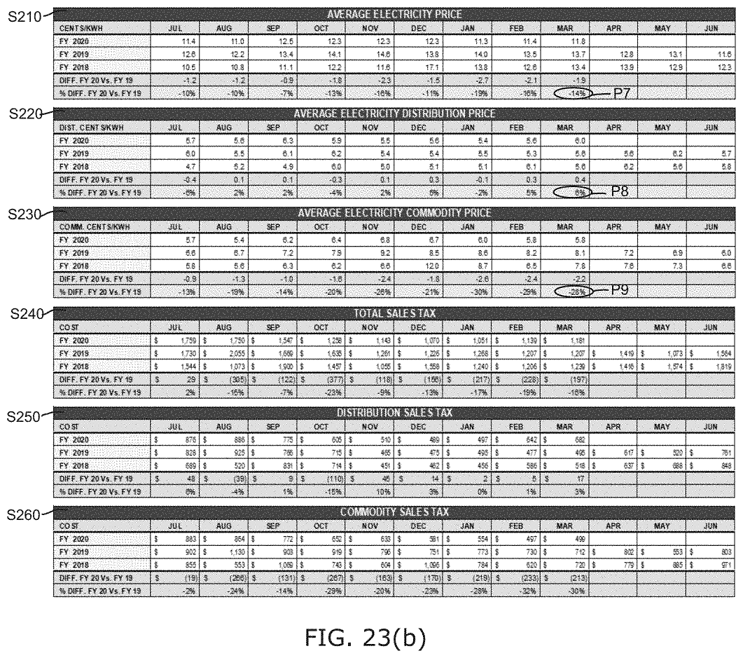

FIGS. 23(a)-23(b) are at the heart of the disclosed invention because they clearly identify how the changes in the electricity data relate to one another—and particularly diagnose and quantify why the electricity cost data is changing. The tabular data in FIGS. 23(a)-23(b) are a direct non-limiting exemplary embodiment of the simplified and standardized electricity billing data cost breakdown of FIG. 19. They are a direct reflection of the cost equation of FIG. 19—rolled out over a 12-month period. The main purpose of these figures is to diagnose the changes in the cost data by decomposing and correlating the monthly rates of change in cost and the monthly rates of change in consumption and prices—and any number of their direct and indirect components and influencers, relative to at least one baseline—where the electricity cost data is averaged by dividing the monthly electricity cost data by the corresponding monthly electricity consumption data—thereby linking cause to effect and automatically, filtering, diagnosing, and valuating the anomalies in the data.

For example, in table S130 of FIG. 23(a) one can derive that the cost reduction of $3,282 (D1) in the month of March 2020 was due to a distribution cost increase of $277 (Table S 140, Item D2) and a commodity cost decrease of $3,558 (Table S150, Item D3); that the 16% cost decrease in the month of March 2020 (Table S130, Item P1) was the result of approximately 3% decrease in energy use (Table S170, Item P5) and a 14% decrease in average electricity price (Table S210, Item P7 of FIG. 23(b)); that the approximately 3% increase in electricity distribution cost in the month of March 2020 was the result of a 10% increase in the number of billing days (Table S160, Item P4), a 12% decrease in average electricity cost per day (Table S180, Item P6), and a 6% increase in the average distribution price of electricity (Table S220, Item P8)—and that the additional 3% increase in distribution cost amounted to $277 in additional electricity cost (Table S140, Item D2). Furthermore, one can derive that the 30% decrease in commodity cost—which amounted to a $3,508 cost decrease (Table S150, Items P3 and D3) was the result of 10% increase in the number of billing days (Table S160, Item P4), a 12% decrease in the average electricity consumption per day (Table 180, Item P6), and a 28% decrease in the average electricity commodity price (Table S230, Item P9 of FIG. 23(b)).

While averages do not always add up correctly, especially when the percentages vary wildly and the measured quantities do not carry the same weight with respect to cost (such as in sales tax); when it comes to quantity and price and the percentage differences do not vary wildly, adding averages makes sense. In the case of sales taxes, a 100% increase in sales tax in not going to result in 100% increase in cost because the maximum contribution of a sales tax to total cost may be around 5% or 6%; so, a 100% increase in a sales tax would only result in a 5% or 6% increase in total cost.

What FIGS. 23(a)-23(b) demonstrate is how the method of this invention can not only fitter and quantify anomalies in the billing data—it can diagnose and valuate the anomalies in the data—especially as they relate to cost.

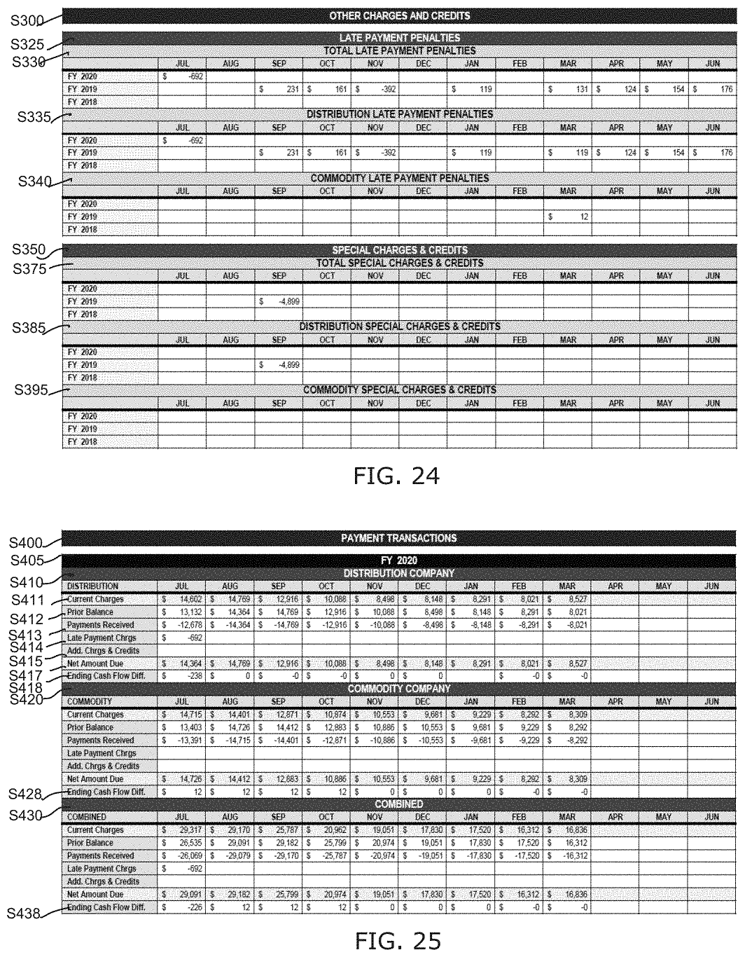

FIG. 24 provides added filtering and quantification related to monthly late payment penalties and special charges and credits. However, these cost factors are irregular and usually result in minimal impact on cost.

FIG. 25 provides added financial oversight regarding the monthly payment transaction between utility company or companies and the customer.

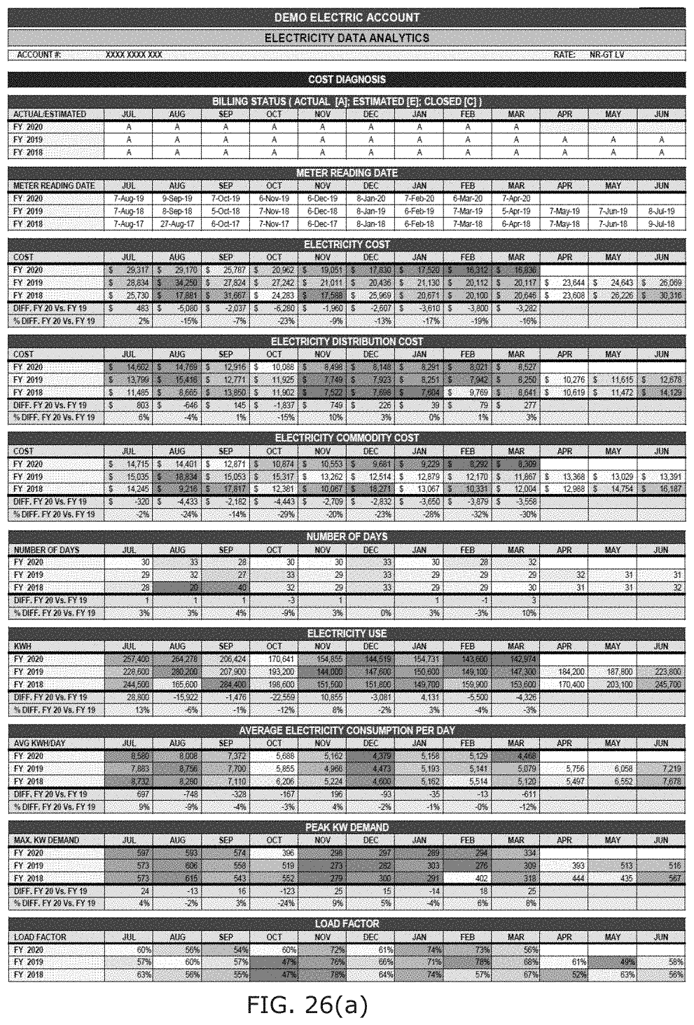

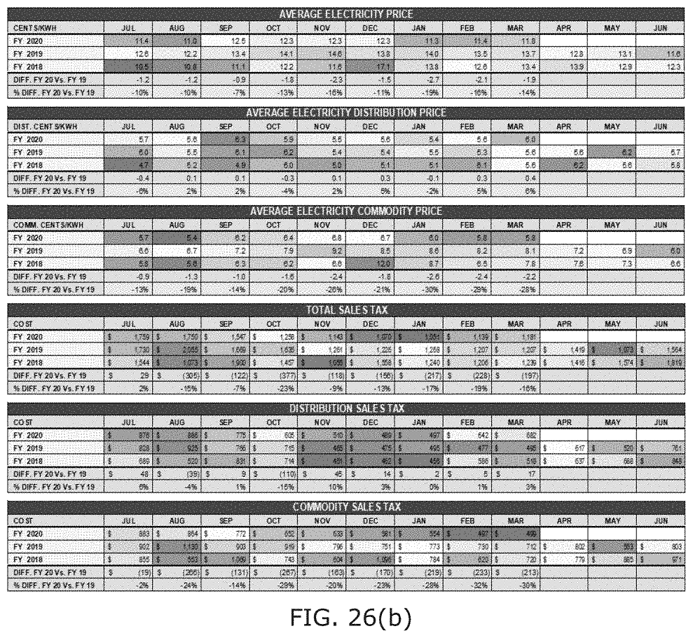

FIGS. 26(a)-26(b) illustrate how the filtering method of FIG. 22(b) which uses color-coding to dynamically rank the data in a data set can provide an enhanced method of flagging out-of-range anomalies in the data.

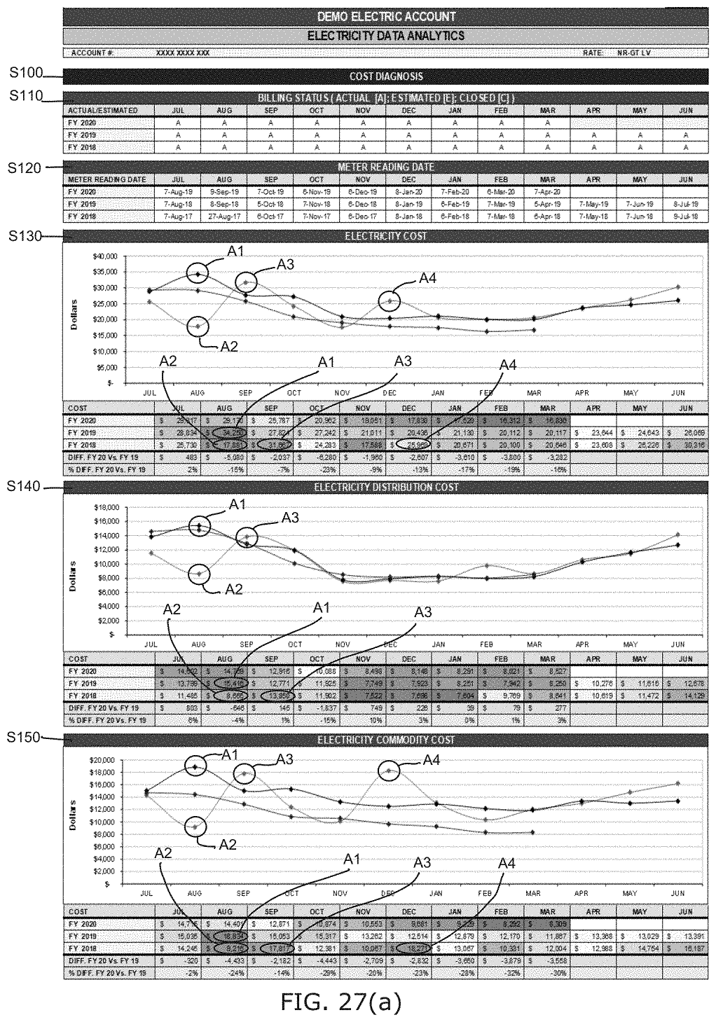

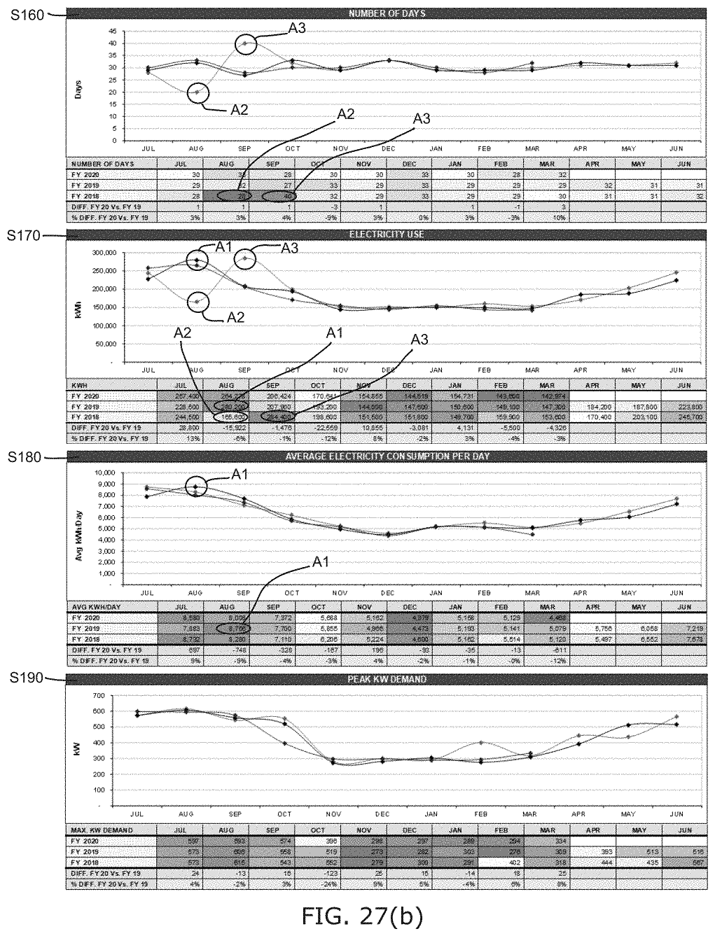

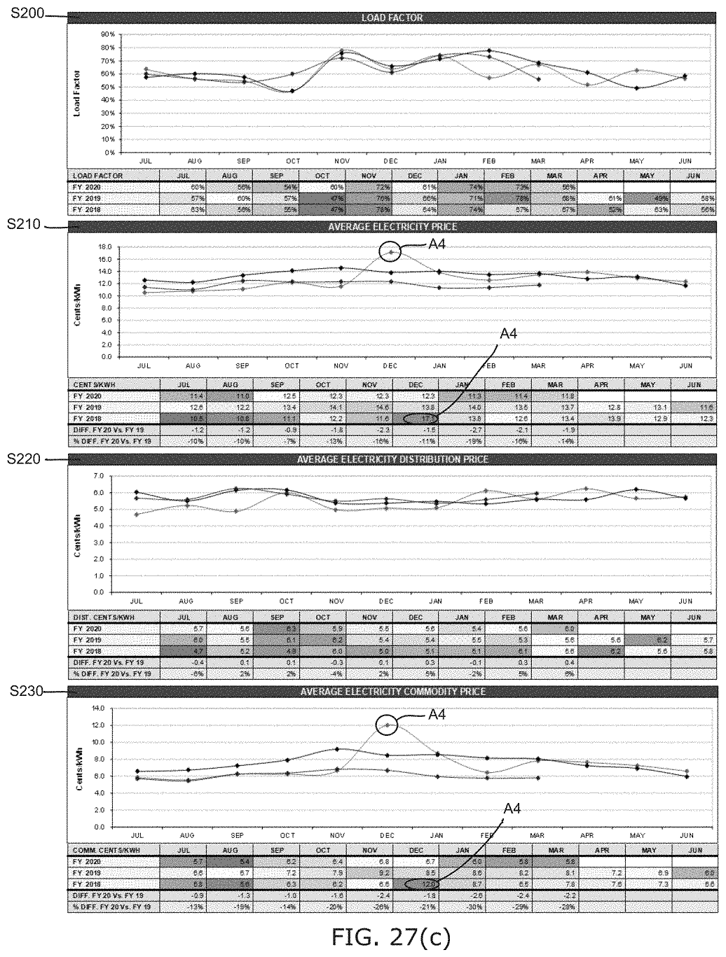

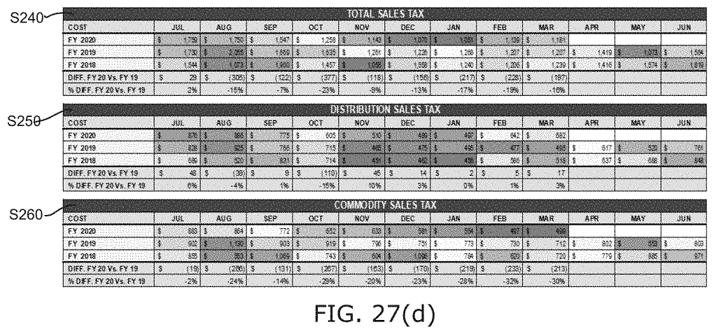

FIGS. 27(a)-27(d) illustrate yet another enhancement to the diagnostic method of the disclosed invention by demonstrating how correlating anomalies in the billing data can uncover unique insights and diagnose hidden operating and financial waste that would otherwise go undetected. The anomalies in FIGS. 27(a)-27(d) can be analyzed as follows:

Cost Anomaly A1 in August 2018 can be traced to noticeably higher electricity consumption during that billing period because there was nothing particularly unusual about the difference in price or the number of billing days during that period—but the average electricity consumption was higher than usual, and it impacted both the cost of electricity distribution and the cost of electricity commodity. Investigative analysis determined that the likely reason for the increase in electricity consumption was due to unusually warm weather during that billing period.

Cost Anomalies A2 and A3 in August and September 2017 can be traced to a noticeably lower number of days in August 2017 and a noticeably higher number of days in September 2017. This is because there were no noticeable changes in the average daily use or the average monthly price of electricity during these two billing periods—but there was a major reduction in the number of billing days in August 2017 and a major increase in the number of billing days in September 2017 that noticeably impacted the cost of utilities during these months.

Cost Anomaly A4 in December 2017 can be traced to a major spike in commodity price during that period. This is because there were no unusual changes in the number of billing days, the amount of energy used, or the distribution price of electricity during that month—but there were substantial jumps in the price and cost of commodity during that month. Upon investigation of this price anomaly with the subject commodity company, it was determined that severe weather caused electricity commodity prices to spike at the end of December 2017 and that the organization lacked a hedging contract to limit its exposure to real-time electricity price swings. The lack of a hedging contract caused the organization to incur more than $180,000 in additional energy costs in a single month. Upon learning of this finding, the organization hired a commodities consultant to hedge the price of its future commodity purchases.

While the use, price, and cost data were charted in FIGS. 27(a)-(c), the sales tax data of FIG. 27(d) was not charted because the rates of change in the sales tax data would have mirrored those of the cost data (since sales taxes are usually a fixed percentage of total costs) and such charting would not have provided any added value to the data.

Finally, it is worth noting that while the above description of the drawings focused on the analytical aspects of the invention, a key component of the invention is including an expert system that, at a minimum, describes the function of each utility account included in the system and enables the interpretation and documentation of the diagnosed anomalies in the data.

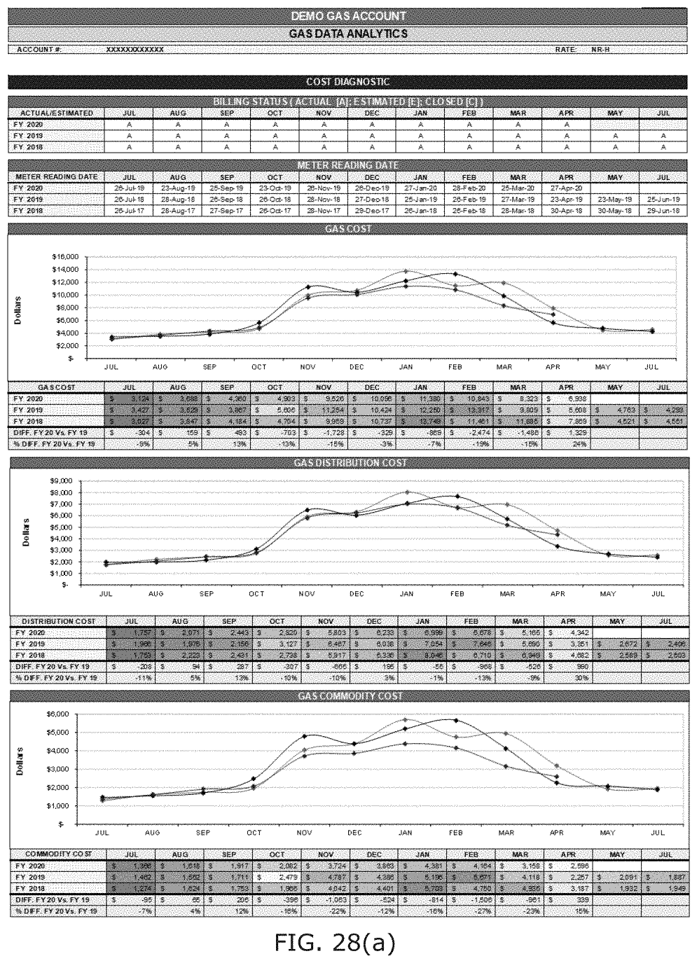

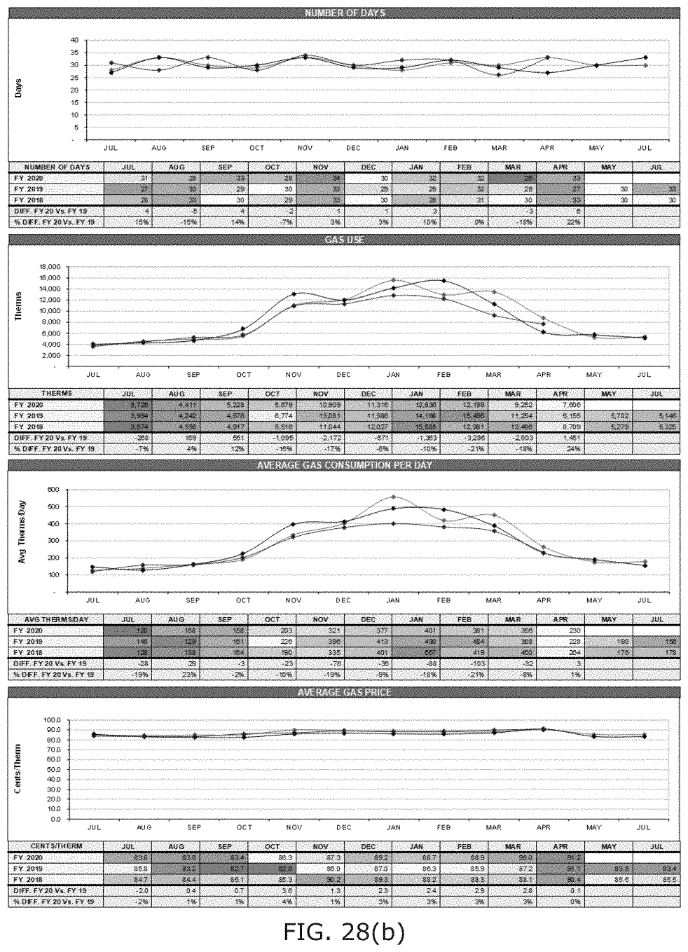

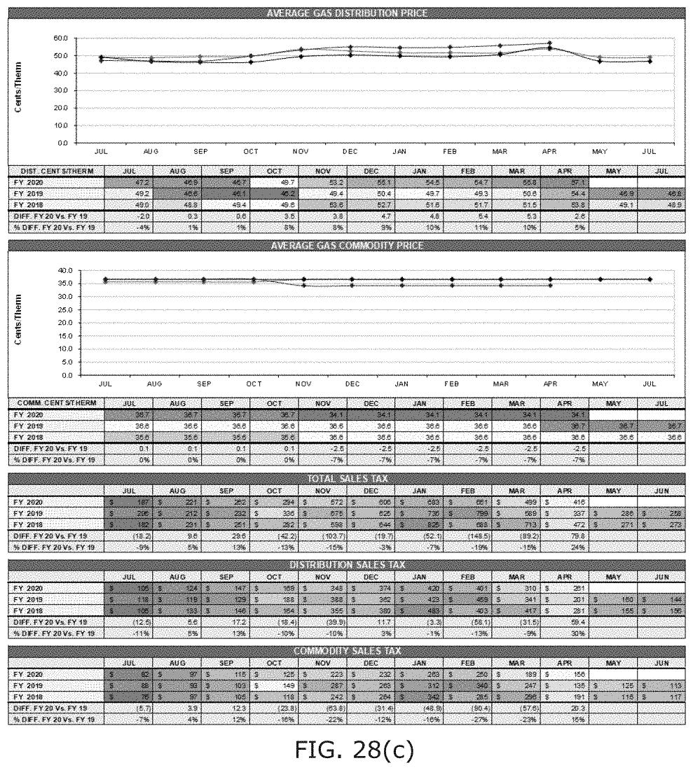

FIGS. 28(a)-28(c) illustrate how the non-limiting exemplary automated cost diagnostic system for electricity accounts which was described above can be applied to gas accounts.

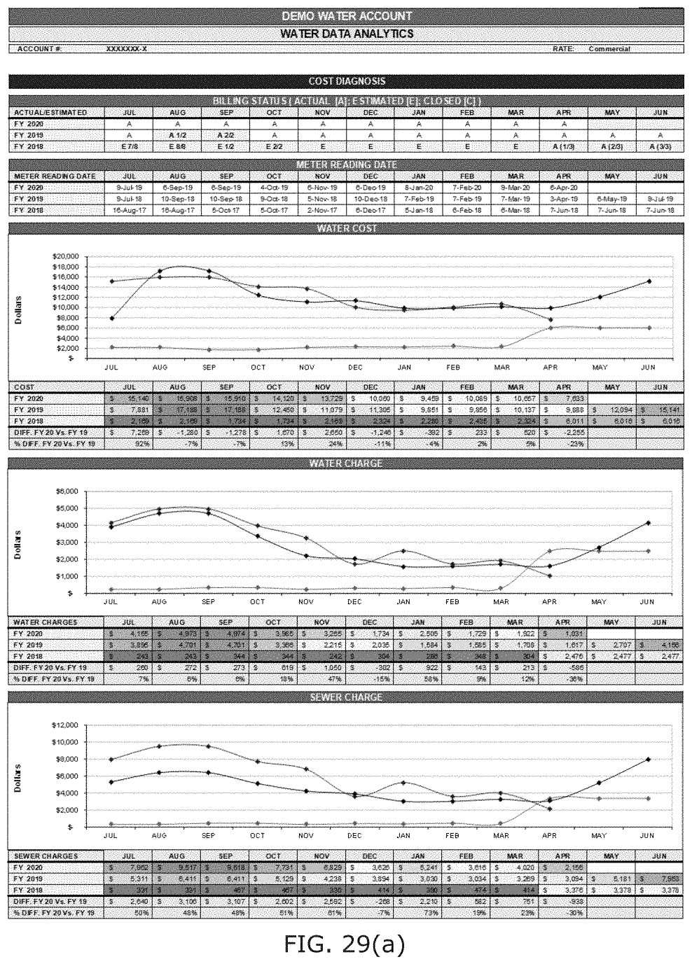

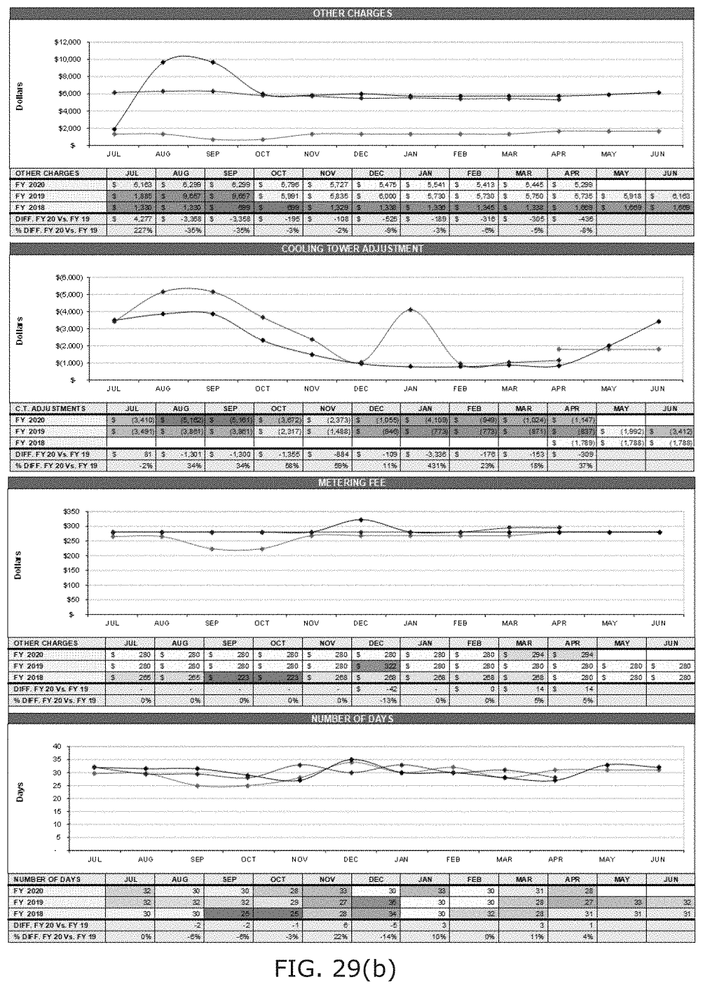

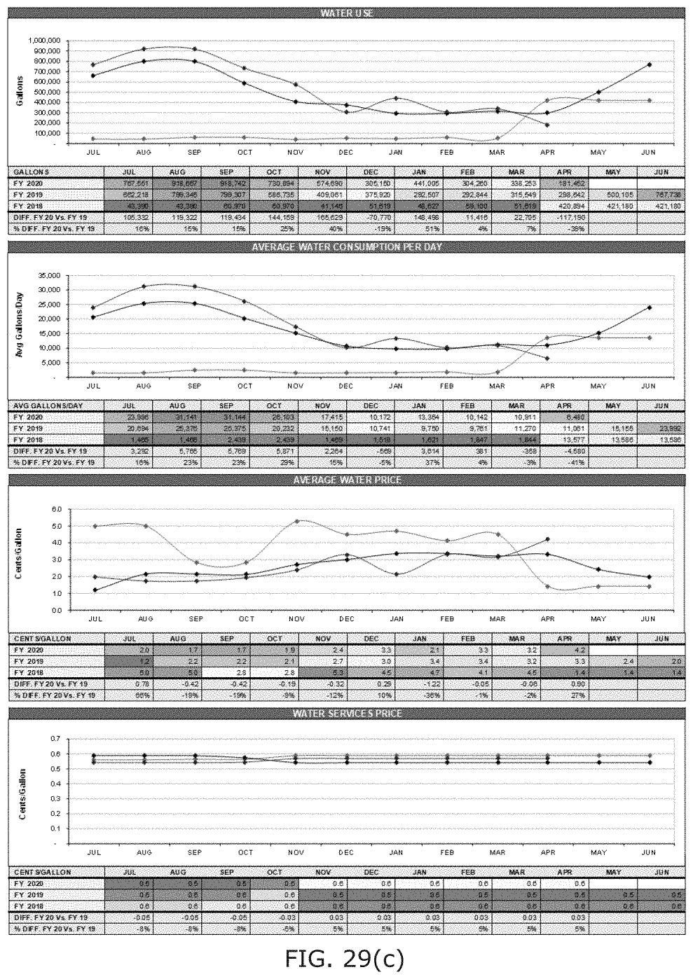

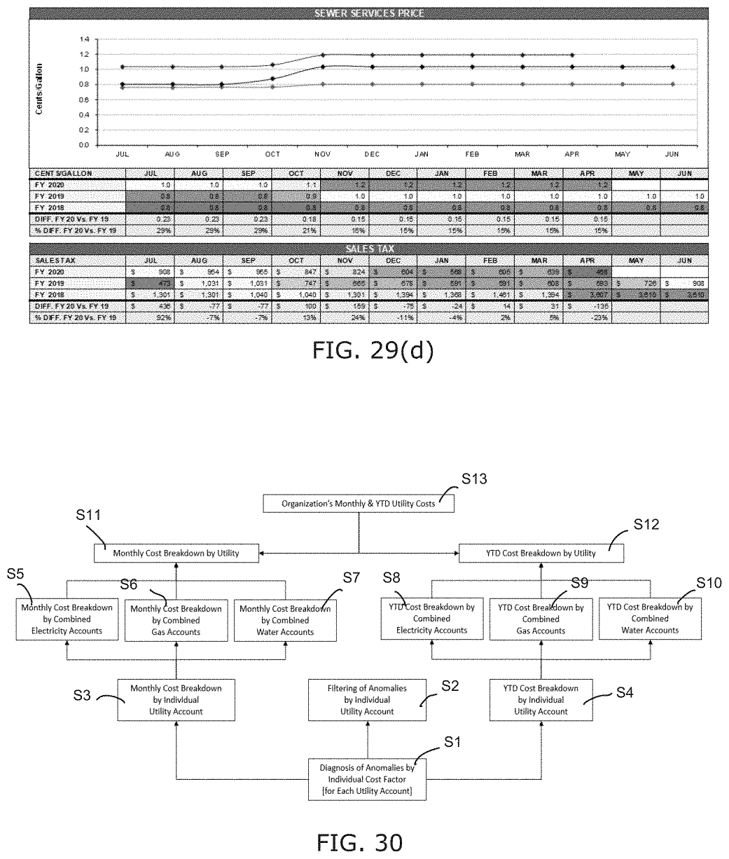

FIGS. 29(a)29(d) illustrate how the non-limiting exemplary automated cost diagnostic system for electricity accounts which was described above can be applied to water accounts.

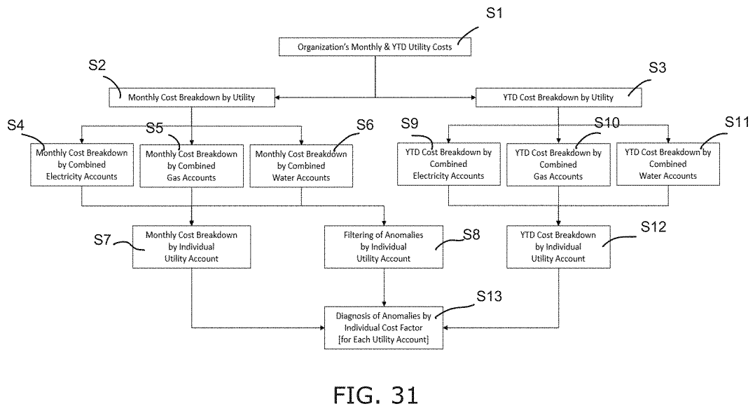

FIGS. 30 and 31 provide a schematic of how the invention described above not only enables the systematic analysis of utility billing data from almost any utility company, and the automated filtering, diagnosis, and valuation of anomalies in the data, it also enables the integration of the energy and water data into a coherent software system that provides instant roll-up and drill-down of utility data from multiple utility companies and utility accounts using simple and concise PDF files. A copy of such system will be provided in an accompanying IDS.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

The claimed invention is:

1. A system and method for the systematic analysis of energy billing data and the automated filtering, diagnosis, and valuation of anomalies in the data, the system comprising:
at least one storage device configured to store current and recent monthly energy billing data and previous monthly energy billing data that are based on, or derived from, energy billing data that are at least 12 months prior to the current monthly billing data, where the current monthly energy data and the previous monthly energy billing data fall on the same month of the year; and
wherein the current and recent monthly billing data and the previous monthly billing data comprise monthly energy use, price, and cost data; and a processor coupled to the storage device, wherein the processor is programmed to:
decompose and synchronize the current and or recent monthly energy use, price, and cost data, and any number of their direct or indirect components and influencers, and the previous monthly energy use, price, and cost data, and any number of their direct or indirect components and influencers; and
systematically compute the monthly change and rate of change between the current monthly energy use, price, and cost data, and any number of their direct and indirect components and influencers, relative to corresponding previous monthly use, price, and cost data, and any number of their direct and indirect components and influencers that are based on or derived from previous billing data that are at least 12 months in arrears in order to systematically quantify, compare, and correlate the changes and anomalies in the monthly energy use and price data and any number of their direct and indirect components and influencers, with changes and anomalies in corresponding monthly energy cost data; thereby linking cause to effect and automatically filtering, diagnosing, and valuating the anomalies in the data; and
a display coupled to the processor, the display configured to output tabular and/or graphical visualization of the comparisons, changes, and rates of changes in the monthly energy data.

2. The system of claim 1 wherein the processor is programed to derive monthly average energy price data by dividing monthly energy cost data by corresponding monthly energy consumption data.

3. The system of claim 1 wherein the processor is programmed to derive monthly average energy consumption per day data by dividing monthly energy consumption data by corresponding number of billing days.

4. The system of claim 1 wherein the processor is programmed to decompose the reported monthly energy cost data by distribution/delivery company costs and supply/commodity company costs.

5. The system of claim 1 wherein the current and/or recent monthly data and the previous monthly data are dynamically ranked each month by color-coding the data according to the value of each data point within their respective data set.

6. The system of claim 1 wherein the current and/or recent monthly data and the previous monthly data are dynamically visualized over at least two 12-month periods.

7. The system of claim 1 wherein the energy use, price, and related cost data are further supplemented by an expert system or a knowledge library that assigns meaning to the data and enables the interpretation and documentation of the diagnosed anomalies in the data.

8. A system and method for the systematic analysis of water billing data and the automated filtering, diagnosis, and valuation of anomalies in the data, the system comprising:
at least one storage device configured to store current and recent monthly water billing data and previous monthly water billing data that are based on, or derived from, water billing data that are at least 12 months prior to the current monthly billing data, where the current monthly water data and the previous monthly water billing data fall on the same month of the year; and
wherein the current and recent monthly billing data and the previous monthly billing data comprise monthly water use, price, and cost data; and a processor coupled to the storage device, wherein the processor is programmed to:
decompose and synchronize the current and or recent monthly water use, price, and cost data, and any number of their direct or indirect components and influencers, and the previous monthly water use, price, and cost data, and any number of their direct or indirect components and influencers; and
systematically compute the monthly change and rate of change between the current monthly water use, price, and cost data, and any number of their direct and indirect components and influencers, relative to corresponding previous monthly use, price, and cost data, and any number of their direct and indirect components and influencers that are based on or derived from previous billing data that are at least 12 months in arrears in order to systematically quantify, compare, and correlate the changes and anomalies in the monthly water use and price data and any number of their direct and indirect components and influencers, with changes and anomalies in corresponding monthly water cost data; thereby linking cause to effect and automatically filtering, diagnosing, and valuating the anomalies in the data; and
a display coupled to the processor, the display configured to output tabular and/or graphical visualization of the comparisons, changes, and rates of changes in the monthly water data.

9. The system of claim 8 wherein the processor is programed to derive monthly average water price data by dividing monthly water cost data by corresponding monthly water consumption data.

10. The system of claim 8 wherein the processor is programmed to derive monthly average water consumption per day data by dividing monthly water consumption data by corresponding number of billing days.

11. The system of claim 8 wherein the current and/or recent monthly data and the previous monthly data are dynamically ranked each month by color-coding the data according to the value of each data point within their respective data set.

12. The system of claim 8 wherein the current and/or recent monthly data and the previous monthly data are dynamically visualized over at least two 12-month periods.

13. The system of claim 8 wherein the water use, price, and related cost data are further supplemented by an expert system or a knowledge library that assigns meaning to the data and enables the interpretation and documentation of the diagnosed anomalies in the data.
